(19) United States
(12) Patent Application Publication
(10) Pub. No.: US 2020/0409300 A1
(43) Pub. Date: Dec. 31, 2020

(54) IMAGE FORMING APPARATUS INCORPORATING DECURLER

(71) Applicant: Takamasa HASE, Tokyo (JP)

(72) Inventor: Takamasa HASE, Tokyo (JP)

(73) Assignee: Ricoh Company, Ltd., Tokyo (JP)

(21) Appl. No.: 16/885,577

(22) Filed: May 28, 2020

(30) Foreign Application Priority Data
Jun. 27, 2019 (JP) 2019-119545

(51) Int. Cl. G03G 15/00; G03G 15/20

(52) U.S. Cl. CPC G03G 15/6558; G03G 2215/00662; G03G 15/2028

(57) ABSTRACT

An image forming apparatus includes an image forming device, a fixing device having a fixing nip region and configured to fix the image to a sheet, and a decurler including a decurling guide configured to correct a curl of the sheet while guiding the sheet after the fixing device. The decurling guide is configured to correct the curl of the sheet while guiding the sheet in a −X direction, where a sheet conveyance direction at a point of origin is a Y direction and a direction perpendicular to the Y direction is an X direction. A relation of 15 mm≤G1y≤25 mm being satisfied, where G1y represents a position from the point of origin in the Y direction is at a point of −15 mm from the point of origin in the X direction on a guide face of the decurling guide.

### CROSS-REFERENCE TO RELATED APPLICATION

This patent application is based on and claims priority pursuant to 35 U.S.C. § 119(a) to Japanese Patent Application No. 2019-119545, filed on Jun. 27, 2019, in the Japan Patent Office, the entire disclosure of which is hereby incorporated by reference herein.

### BACKGROUND

### Technical Field

This disclosure relates to an image forming apparatus incorporating a decurler.

### Discussion of the Background Art

Various types of image forming apparatuses are known to include: an image forming device for forming an image on a sheet; a fixing device provided with a rotary heat member heated by a heater, and a rotary nip forming member for forming a fixing nip region with the rotary heat member in contact with the rotary nip forming member so as to cause the sheet having the image to pass the fixing nip region for fixing the image to the sheet; and a decurler provided with a decurling guide for correcting a curl of the sheet while guiding the sheet after passing the fixing device.

### SUMMARY

At least one aspect of this disclosure provides an image forming apparatus including an image forming device, a fixing device, and a decurler. The image forming device is configured to form an image on a sheet. The fixing device includes a heater, a rotary heat member and a rotary nip forming member. The rotary heat member is configured to be heated by the heater. The rotary nip forming member is configured to contact the rotary heat member to form a fixing nip region. The fixing device is configured to pass the sheet with the image, through the fixing nip region in a sheet conveyance direction, in which the sheet is conveyed, to fix the image to the sheet, The decurler includes a decurling guide configured to correct a curl of the sheet while guiding the sheet after the fixing device. The decurling guide has a guide face configured to face a surface of the sheet having contacted the rotary nip forming member in the fixing nip region. The decurling guide is configured to correct the curl of the sheet while guiding the sheet in a −X direction, where a downstream end of the fixing nip region in the sheet conveyance direction is a point of origin, the sheet conveyance direction at the point of origin is a Y direction, a direction perpendicular to the Y direction is an X direction, and a side toward the rotary nip forming member from the point of origin is a +X direction, and a direction opposite the +X direction is the −X direction, when the image forming apparatus is viewed from an axial direction of the rotary nip forming member. A relation of 15 mm≤G1y≤25 mm is satisfied, where G1y represents a position from the point of origin in the Y direction is at a point of −15 mm from the point of origin in the X direction on a guide face of the decurling guide.

### BRIEF DESCRIPTION OF THE SEVERAL VIEWS OF THE DRAWINGS

An exemplary embodiment of this disclosure will be described in detail based on the following figured, wherein:

FIG. 1 is a schematic configuration diagram illustrating an image forming apparatus according to an embodiment of this disclosure;

FIG. 2 is a diagram illustrating a fixing device according to the present embodiment;

FIG. 3 is a diagram illustrating the fixing device and a decurler;

FIG. 4 is a diagram illustrating the image forming apparatus indicating the relation of the minimum radius of curvature R of a guide face of a decurling guide in the region on a +X direction side from a first position G1 and a sheet ejecting position;

FIG. 5 is a diagram illustrating a fixing device and a decurling mechanism of the image forming apparatus of Variation of the present embodiment;

FIG. 6 is a diagram illustrating the main part of a printer used for Comparative Example 1;

FIG. 7 is a diagram illustrating the main part of a printer used for Comparative Example 2;

FIG. 8 is a diagram illustrating the main part of a printer used for Comparative Example 3;

FIG. 9 is a diagram illustrating the main part of a printer used for Embodiments 1 to 4;

FIG. 10 is a diagram illustrating the main part of a printer used for Embodiments 5 to 8;

FIG. 11 is a diagram illustrating the main part of a printer used for Embodiments 9 to 12;

FIG. 12 is a diagram illustrating the main part of a printer used for Embodiments 13 to 16;

FIG. 13 is a diagram illustrating the main part of a printer used for Embodiments 17 to 21;

FIG. 14 is a diagram illustrating the main part of a printer used for Embodiments 22 to 26;

FIG. 15 is a diagram illustrating the main part of a printer used for Embodiments 27 to 31;

FIG. 16 is a diagram illustrating the main part of a printer used for Embodiments 32 to 36;

FIG. 17 is a diagram illustrating the main part of a printer used for Embodiments 37 to 41;

FIG. 18 is a diagram illustrating the main part of a printer used for Embodiments 42 to 46;

FIG. 19 is a diagram illustrating the main part of a printer used for Embodiments 47 to 51;

FIG. 20 is a diagram illustrating the main part of a printer used for Embodiments 52 to 56;

FIG. 21 is a diagram illustrating the main part of a printer used for Embodiments 57 to 60;

FIG. 22 is a diagram illustrating the main part of a printer used for Embodiments 61 to 65;

FIG. 23 is a diagram illustrating the main part of a printer used for Embodiments 66 to 70;

FIG. 24 is a diagram illustrating the main part of a printer used for Embodiments 71 to 75;

FIG. 25 is a diagram illustrating the main part of a printer used for Embodiments 76 to 80;

FIG. 26 is a diagram illustrating the main part of a printer used for Embodiments 81 to 84;

FIG. 27 is a diagram illustrating the main part of a printer used for Embodiments 85 to 89;

FIG. 28 is a diagram illustrating the main part of a printer used for Comparative Example 4;

FIG. 29 is a diagram illustrating the main part of a printer used for Comparative Example 5; and

FIG. 30 is a diagram illustrating the main part of a printer used for Embodiments 90 to 106.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Referring now to the drawings, embodiments of the present disclosure are described below. In the drawings for explaining the following embodiments, the same reference codes are allocated to elements (members or components) having the same function or shape and redundant descriptions thereof are omitted below.

Now, descriptions are given of an electrophotographic image forming apparatus 100 for forming color images by electrophotography, according to an embodiment of this disclosure. It is to be noted that, hereinafter, the electrophotographic image forming apparatus 100 is referred to as the image forming apparatus 100.

First, a description is given of a basic configuration of the image forming apparatus 100 according to the present embodiment of this disclosure.

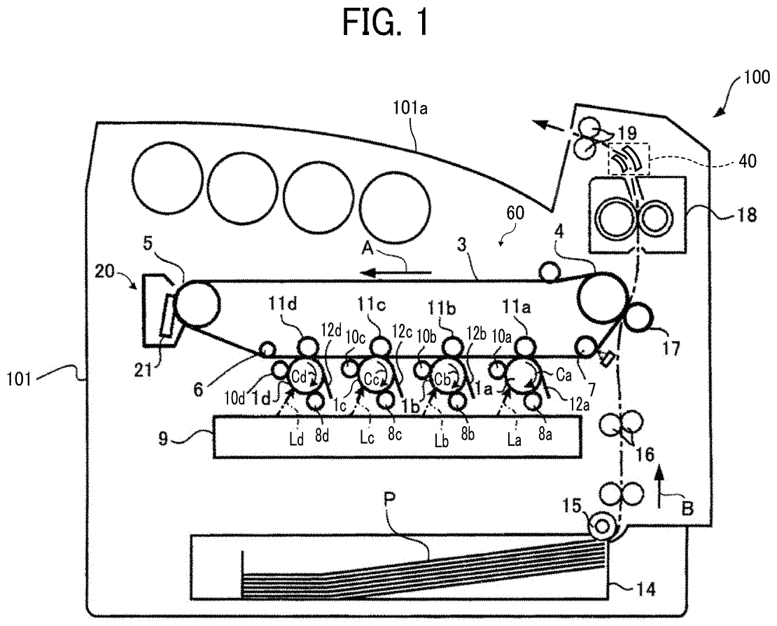

FIG. 1 is a diagram illustrating the image forming apparatus 100 according to an embodiment of this disclosure.

The image forming apparatus 100 is a tandem type color printer and is provided with four photoconductors 1a, 1b, 1c, and 1d as first, second, third, and fourth image bearers, respectively, disposed in a housing 101 of the image forming apparatus 100. Note that the photoconductors 1a, 1b, 1c, and 1d collectively function as an image forming device.

An intermediate transfer device 60, which is a belt device having an intermediate transfer belt 3 that functions as a belt, is provided above the four photoconductors 1a, 1b, 1c, and 1d.

Different color toner images are formed on the four photoconductors 1a, 1b, 1c, and 1d. Black toner images, cyan toner images, magenta toner images, and yellow toner images are formed on the four photoconductors 1a, 1b, 1c, and 1d according to the present embodiment, respectively. Note that the photoconductors 1a, 1b, 1c, and 1d in FIG. 1 are drum-shaped photoconductors but may have photoconductors having an endless belt to rotate while being wound around a plurality of rollers.

The image forming apparatus 100 further includes an intermediate transfer belt 3 that functions as an intermediate transfer body. The intermediate transfer belt 3 is disposed facing the four photoconductors 1a, 1b, 1c, and 1d (to be more specific, the first photoconductor 1a, the second photoconductor 1b, the third photoconductor 1c, and the fourth photoconductor 1d). In FIG. 1, the four photoconductors 1a, 1b, 1c, and 1d are in contact with the surface of the intermediate transfer belt 3. The intermediate transfer belt 3 illustrated in FIG. 1 is wound around support rollers, which are a secondary transfer counter roller 4, a tension roller 5, a backup roller 6, and an entrance roller 7. The secondary transfer counter roller 4 that functions as one of the support rollers is a drive roller that is driven by a drive source. As the secondary transfer counter roller 4 rotates, the intermediate transfer belt 3 is rotated n a direction indicated by arrow A in FIG. 1.

The intermediate transfer belt 3 may include either a plurality of layers or a single layer. The plurality of layers preferably includes a base layer having an outer circumferential surface coated by a smooth coating layer made of, e.g., fluorine-based resin.

The base layer may be made of, for example, a stretch-resistant fluororesin, polyvinylidene difluoride (PVDF) sheet, or polyimide resin. The single layer may be preferably made of, for example, PVDF, polycarbonate (PC), or polyimide.

Regardless of the color of toner, the configuration and operation to form toner images on the four photoconductors 1a, 1b, 1c, and 1d are similar. Similarly, the configuration and operation to transfer the toner images onto the intermediate transfer belt 3 are similar regardless of the color of toner. Accordingly, a description is given of the configuration and operations of the photoconductor 1d mainly, out of the four photoconductors 1a, 1b, 1c, and 1d. The photoconductor 1d for forming a yellow toner image is disposed extreme upstream in a belt surface moving direction of the intermediate transfer belt 3. The photoconductor 1d forms a yellow toner image on the surface and transfers the yellow toner image onto the surface of the intermediate transfer belt 3. Descriptions of the configuration and operation regarding the photoconductors 1a, 1b, and 1c forming other toner color images (cyan toner image, magenta toner image, and black toner image) are omitted to avoid redundancy.

The photoconductor 1d for forming a yellow toner image is rotationally driven in the clockwise direction in FIG. 1 as indicated by an arrow C in FIG. 1. Hereinafter, the photoconductor 1d for forming a yellow toner image is simply referred to as the photoconductor 1d. As the photoconductor 1d is rotated, the surface of the photoconductor 1d is irradiated with light from a static eliminator. Consequently, the surface potential of the photoconductor 1d is initialized. The photoconductor 1d is further rotated and reaches a position where the photoconductor 1d faces a charging device 8d that has an identical configuration to charging devices 8a, 8b, and 8c except for the toner colors. The charging device 8d uniformly charges the initialized outer circumferential surface of the photoconductor 1d to a given polarity (in the present embodiment, to a negative polarity). An exposure device 9 disposed below the photoconductors 1a, 1b, 1c, and 1d emits laser light beams La, Lb, Lc, and Ld onto the charged outer circumferential surfaces of the respective photoconductors 1a, 1b, 1c, and 1d according to black, cyan, magenta, and yellow image data contained in image data sent from the external device, respectively, thus forming electrostatic latent images on the respective outer circumferential surfaces. In the image forming apparatus 100 of FIG. 1, the exposure device 9 as a laser writer emits the laser beams La, Lb, Lc, and Ld. Alternatively, the exposure device 9 may include a light-emitting diode (LED) array and an imaging device.

The electrostatic latent image formed on the photoconductor 1d is visualized as a visible yellow toner image by a developing device 10d that has an identical configuration to developing devices 10a, 10b, and 10c except for the toner colors. Further, primary transfer rollers 11a, 11b, 11c, and 11d are disposed inside a loop formed by the intermediate transfer belt 3. The primary transfer rollers 11a, 11b, 11c, and 11d are disposed opposing (facing) the photoconductors 1a, 1b, 1c, and 1d, respectively, via the intermediate transfer belt 3. The primary transfer roller 11d is brought to contact the back surface of the intermediate transfer belt 3, forming a transfer nip region between the photoconductor 1d and the intermediate transfer belt 3 properly.

A primary transfer bias is applied to the primary transfer roller 11d. The primary transfer bias has a positive polarity in the present embodiment, that is opposite a toner charging polarity of toner contained in the yellow toner image formed on the surface of the photoconductor 1d. Thus, a transfer electrical field is generated between the photoconductor 1d and the intermediate transfer belt 3. The yellow toner image on the photoconductor 1d is electrically (electrostatically) transferred onto the intermediate transfer belt 3 that is rotated in synchronization with the photoconductor 1d. After the yellow toner image is transferred onto the intermediate transfer belt 3, a cleaning device 12d Bk having an identical configuration to cleaning devices 12a, 12b, and 12c removes residual toner remaining on the surface of the photoconductor 1d to clean the surface of the photoconductor 1d.

Similarly, a black toner image, a cyan toner image, and a magenta toner image are respectively formed on the photoconductors 1a, 1b, and 1c, and the toner images of respective colors are sequentially superimposed and electrically (electrostatically) transferred one after another on the yellow toner image on the intermediate transfer belt 3.

The image forming apparatus 100 has two types of drive modes, which are a full color mode in which four color toners are used and a monochrome mode in which black color toner alone is used. In the full color mode, the intermediate transfer belt 3 and each of the four photoconductors 1a, 1b, 1c, and 1d come into contact with each other, and the four color toner images are transferred onto the intermediate transfer belt 3.

By contrast, in the monochrome mode, the photoconductor 1a alone contacts the intermediate transfer belt 3, so that black toner alone is transferred to the intermediate transfer belt 3. At this time, the three photoconductors 1b, 1c, and 1d for cyan toner image, magenta toner image, and yellow toner image are not in contact with the intermediate transfer belt 3, and the three primary transfer rollers 11b, 11c, and 11d are separated from the three photoconductors 1b, 1c, and 1d, respectively. In order to reliably separate the intermediate transfer belt 3 from the three photoconductors 1b, 1c, and 1d for cyan toner image, magenta toner image, and yellow toner image, the backup roller 6 is moved to change the profile of the intermediate transfer belt 3.

As illustrated in FIG. 1, the image forming apparatus 100 further includes a sheet feeding device 14 in the housing 101. The sheet feeding device 14 includes a sheet feed roller 15. As the sheet feed roller 15 rotates, a recording sheet P that functions as a recoding medium is fed out in a direction indicated by arrow B in FIG. 1. The recording sheet P fed out from the sheet feeding device 14 contacts a pair of registration rollers 16 and stops temporarily.

A portion of the intermediate transfer belt 3 is wound around the secondary transfer counter roller 4. The portion of the intermediate transfer belt 3 contacts a secondary transfer roller 17 that functions as a secondary transfer member disposed facing the secondary transfer counter roller 4. Thus, a secondary transfer nip region is formed between the secondary transfer roller 17 and the secondary transfer counter roller 4 via the intermediate transfer belt 3. The recording sheet P that has contacted the pair of registration rollers 16 is conveyed to the secondary transfer nip region at a given timing. At this time, a given transfer voltage is applied to the secondary transfer roller 17, so that a composite toner image formed by interposing the single color toner images on the surface of the intermediate transfer belt 3 is secondarily transferred onto the recording sheet P.

The recording sheet P on which the composite toner image is formed by secondary transfer is further conveyed upward in the image forming apparatus 100 to pass the fixing device 18. When passing the fixing device 18, the composite toner image on the recording sheet P is fixed to the recording sheet P by application of heat and pressure in the fixing device 18. The recording sheet P that has passed the fixing device 18 is ejected to the outside of the image forming apparatus 100 by a pair of sheet ejection rollers 19 disposed in a sheet ejection device, so that the recording sheet P is stacked on a sheet ejection tray 101a that is a top portion of the image forming apparatus 100.

After the toner image is transferred onto the recording sheet P, some toner remains as transfer residual toner on the surface of the intermediate transfer belt 3. The transfer residual toner is removed from the intermediate transfer belt 3 by a belt cleaning device 20. The belt cleaning device 20 includes a cleaning blade 21 that is a blade-shaped urethane cleaning body.

The cleaning blade 21 is disposed in contact with the outer circumferential surface of the intermediate transfer belt 3 in a counter direction with respect to the surface moving direction of the intermediate transfer belt 3 Various types of belt cleaning devices are applied as the belt cleaning device 20. For example, an electrostatic belt cleaning device may be applied.

Now, a description is given of the fixing device 18 according to the present embodiment.

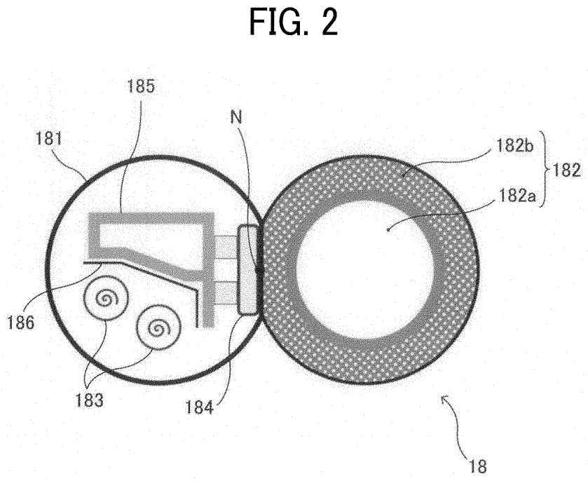

FIG. 2 is a diagram illustrating the fixing device 18 according to the present embodiment.

The fixing device 18 according to the present embodiment includes a fixing belt 181, a pressure roller 182, two heaters 183, and a nip forming plate 184. The fixing belt 181 is an endless belt that functions as a rotary heat member. The pressure roller 182 functions as a rotary nip forming member. Each of the two heaters 183 functions as a heater to heat the fixing belt 181. The nip forming plate 184 functions as a nip forming member disposed facing the pressure roller 182 via the fixing belt 181. The nip forming plate 184 is disposed in contact with an inner circumferential surface of the fixing belt 181, to sandwich (hold) the fixing belt 181 with the pressure roller 182. By so doing, a fixing nip region N is formed between the pressure roller 182 and the fixing belt 181 at a portion contacting the nip forming face of the nip forming plate 184.

The fixing belt 181 is an endless belt or film made of a metal material, such as nickel or stainless steel (e.g., steel use stainless or SUS), or a resin material such as polyimide. The fixing belt 181 is constructed of a base layer and a release layer. The release layer, as an outer surface layer of the fixing belt 181, is made of tetrafluoroethylene-perfluoroalkyl vinyl ether copolymer (PFA), polytetrafluoroethylene (PTFE), or the like to facilitate separation of toner of the toner image on the recording sheet P from the fixing belt 181. An elastic layer made of, e.g., silicone rubber may be interposed between the base layer and the release layer of the fixing belt 181. If the fixing belt 181 does not incorporate the elastic layer, the fixing belt 181 has a decreased thermal capacity that enhances the fixing property. However, slight surface asperities in the fixing belt 181 may be transferred onto the toner image on the sheet S, resulting in variation in gloss of the solid toner image that may appear as an orange peel image on the recording sheet P. In order to address this situation, the fixing belt 181 preferably incorporate an elastic layer having a thickness not smaller than 100 μm, for example. As the elastic layer deforms, the elastic layer absorbs the slight surface asperities in the fixing belt 181, thereby preventing formation of the faulty orange peel image.

The heaters 183 are disposed opposite the inner circumferential surface of the fixing belt 181 to heat the fixing belt 181. The heaters 183 according to the present embodiment are halogen heaters. However, the type and number of heaters 183 are not fixed. In other words, the type and number of heaters 183 depend on the fixing device 18 according to the present embodiment. For example, alternative to the heaters 183, a heater such as an induction heater (IH), a resistive heat generator, or a carbon heater is applied.

The pressure roller 182 is an elastic roller in which the periphery of a cored bar 182a is covered by an elastic rubber layer 182b. The surface layer of the pressure roller 182 has the hardness lower than the hardness of the nip forming surface of the nip forming plate 184. The elastic rubber layer 182b of the pressure roller 182 may be solid rubber but is preferable to include sponge rubber. The sponge rubber is preferable to the solid rubber because the sponge rubber has enhanced thermal insulation that draws less heat from the fixing belt 181 to the pressure roller 182. Further, the pressure roller 182 includes a surface release layer made of PFA or PTFE to facilitate separation of the recording sheet P from the pressure roller 182.

The pressure roller 182 includes a shaft that is supported by a housing of the fixing device 18. As a driving force is generated by a drive source such as a motor mounted on the housing 101 of the image forming apparatus 100, the driving force is transmitted to the pressure roller 182 through a gear train, and the pressure roller 182 rotates in a rotational direction. In the fixing nip region N, the rotation driving force is transmitted from the pressure roller 182, and the fixing belt 181 is rotated along with rotation of the pressure roller 182. On the other hand, at a circumferential span of the fixing belt 181 other than the fixing nip region N, the fixing belt 181 rotates while being guided by the flange of a holding member at each lateral end of the fixing belt 181. The lateral end of the fixing belt 181 is an end in the axial direction of the fixing belt 181, that is, longitudinal direction of the fixing belt 181. At this time, the fixing belt 181 rotates while causing the inner peripheral surface to slide on the nip forming surface of the nip forming plate 184. A slidability enhancing member such as a sliding sheet may be interposed between the nip forming surface of the nip forming plate 184 and the inner peripheral surface of the fixing belt 181 to enhance the sliding performance of the fixing belt 181.

The nip forming plate 184 is fixedly mounted and supported on a stay 185. The stay 185 also has a function of restraining the bending of the nip forming plate 184 when the nip forming plate 184 is pressed by the pressure roller 182 and forming the fixing nip region N uniformly in the width direction of the fixing belt 181. By receiving the pressure from the pressure roller 182 at the stay 185, the nip forming plate 184 obtains the surface pressure in the fixing nip region N to fuse and fix toner on the toner image to the recording sheet P. Further, the stay 185 is held and secured by the holder to be positioned at either end of the stay 185.

The stay 185 is formed by bending iron or stainless steel and has a large heat capacity with an iron plate or a SUS plate having a thickness of approximately 2 mm to 4 mm. Therefore, a reflector 186 is interposed between each of the heaters 183 and the stay 185. The reflector 186 reflects the heat radiating from the heaters 183 toward the inner periphery of the fixing belt 181, thereby preventing the stay 185 from being heated unnecessarily by the heaters 183 and restraining waste of energy. Note that, instead of providing the reflector 186, the surface of the stay 185 may be heat-insulated or mirror-finished.

The nip forming plate 184 according to the present embodiment has a substantially flat nip forming face. Since the nip forming face of the nip forming plate 184 has higher hardness than the hardness of the elastic rubber layer 182b of the pressure roller 182, the elastic rubber layer 182b of the pressure roller 182 elastically deforms along the nip forming face of the nip forming plate 184. Therefore, the fixing nip region N of the present embodiment is substantially flat along the nip forming face (flat face) of the nip forming plate 184. Note that the nip forming face may not be completely flat but, as long as the curvature is sufficiently smaller than the curvature of a known fixing nip region formed by two rollers, the nip forming face may have a slight curved shape such as a convex shape or a concave shape.

In the present embodiment, according to the fixing device 18 having the above-described configuration, the fixing belt 181 has a structure with a low heat capacity and a heating performance of the heaters 183 to heat the fixing belt 181 efficiently in a short time.

In this embodiment, the warm-up operation is performed to raise the temperature of the fixing belt 181 to the specified fixing temperature before starting the image forming operation. In the fixing device 18 according to the present embodiment, the fixing belt 181 has the structure with a low heat capacity, thereby heating the fixing belt 181 to the specified fixing temperature in a short time and reducing the period of the warm-up time.

A known image forming apparatus includes a fixing device, a pair of sheet conveying rollers for conveying a sheet passing through a fixing nip region of the fixing device, and a decurler provided with a decurling guide for correcting a curl of the sheet after passing through a sheet conveyance nip region of the pair of sheet conveying rollers. The decurling guide of the known image forming apparatus bends the curl of the sheet in a direction opposite a sheet curl direction to correct the curl of the sheet while guiding the sheet.

However, due to the layout of the decurling guide, the known image forming apparatus is not likely to correct the curl of the sheet properly.

In the present embodiment, the recording sheet P that has passed through the fixing device 18 is curled (back-edge curl) toward the side opposite the image forming face (i.e., the side in contact with the fixing belt 181). The fixing belt 181 is directly heated by the heat source (the heaters 183) while the pressure roller 182 is heated by the heat transmitted from the fixing belt 181, so that the temperature of the pressure roller 182 is lower than the temperature of the fixing belt 181. Therefore, the temperature of the image forming face (in other words, the face contacting the fixing belt 181) of the recording sheet P becomes different from the temperature of a non-image forming face (in other words, the face contacting the pressure roller 182) of the recording sheet P. Consequently, water contained in the recording sheet P moves from the image forming face (the face contacting the fixing belt 181) having a higher temperature to the non-image forming face (the face contacting the pressure roller 182) having a lower temperature, and therefore the amount of water evaporation on the non-image forming face side becomes greater than the amount of water evaporation on the image forming face side. As a result, the amounts of water evaporation are different between the image forming face and the non-image forming face. Since the fibers of the recording sheet P shrink due to evaporation of water, the non-image forming face having a greater amount of water evaporation has a greater amount of shrinkage than the amount of shrinkage of the image forming face side having a smaller amount of water evaporation. As a result, a back-edge curl bending toward the non-image forming face occurs to the recording sheet P.

In particular, when the fixing device 18 is warmed up from the cold state, the temperature of the fixing belt 181 rises to the specified fixing temperature while the temperature of the pressure roller 182 has not risen sufficiently. Therefore, it is likely that a print job starts when there is a large difference in temperature between the fixing belt 181 and the pressure roller 182. As a result, the recording sheet P may have a larger back-edge curl.

Further, the recording sheet P that has been left in a high temperature and high humidity environment for a long time absorbs moisture to increase the water content. In particular, recycled paper has a high hygroscopic property and tends to have a high water content. As described above, in a recording sheet P having a high water content, the amount of water evaporated from the recording sheet P increases, the difference in the amount of water evaporation between the back side and the front side of the recording sheet P tends to increase, thereby increasing the back-edge curl easily.

Therefore, in the present embodiment, a decurling mechanism 40 is provided as illustrated in FIG. 1. The decurling mechanism 40 functions as a decurler to bend the recording sheet P toward downstream from the fixing device 18 in the sheet conveyance direction, which is a direction opposite a sheet curling direction in which the recording sheet P curls (the back-edge curl in the present embodiment) to correct the curl of the recording sheet P.

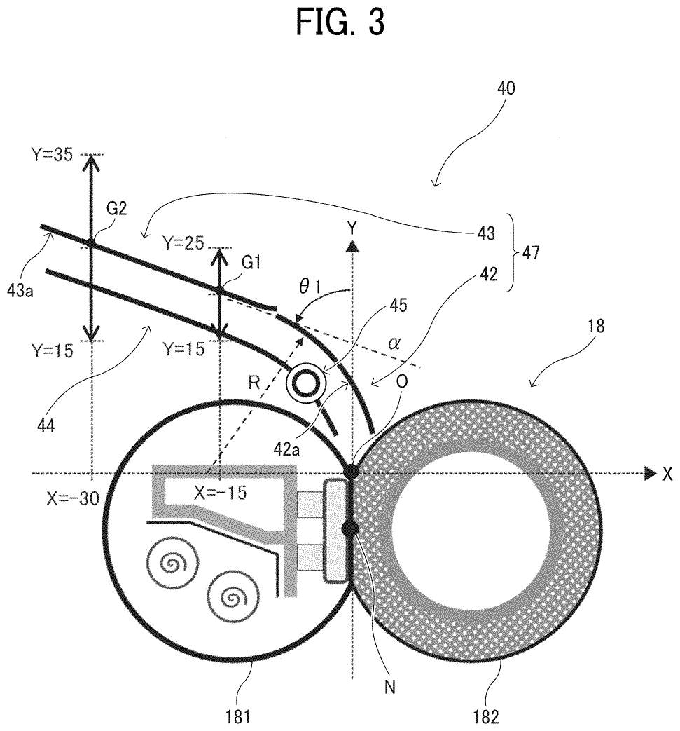

FIG. 3 is a diagram illustrating the fixing device 18 and the decurling mechanism 40.

The decurling mechanism 40 that functions as a decurler is disposed downstream from the fixing device 18 in the sheet conveyance direction. The decurling mechanism 40 includes a fixing device exit guide 42, a non-image forming side guide 43, and an image forming side guide 44 that functions as an opposite decurling guide. The image forming side guide 44 is provided with a driven roller 45 that does not apply a driving force and is rotated by a sheet conveyance force of the recording sheet P. In the present embodiment, the fixing device exit guide 42 and the non-image forming side guide 43 are separately provided but may be integrally provided as a single unit. The fixing device exit guide 42 and the non-image forming side guide 43 are components of a decurling guide 47 that corrects the curl of the recording sheet P while guiding the recording sheet P that has passed through the fixing device 18. The decurling guide 47 faces the image forming side guide 44 across a sheet conveyance passage.

The driven roller 45 is a roller having a diameter of 5 mm to 10 mm and includes a cored bar made of, for example, aluminum or stainless steel (SUS), an outer layer made of a sponge or a rubber layer, and an outermost surface layer coated by a release layer made of PFA or PTFE, so as to prevent from toner from easily attaching to the driven roller 45. Further, the driven roller 45 may be a roller that is made uniform in the axial direction or may have a plurality of rollers each having an axial length of 5 mm to 10 mm arranged in the axial direction. The image forming side guide 44 provided with the driven roller 45 reduces occurrence of rubbing the image on the image forming face side of the recording sheet P and enhances the sheet conveyance performance of a recording sheet.

In the present embodiment, the image forming side guide 44 is configured by a single member but may be divided into a plurality of separate members.

The fixing device exit guide 42 is disposed downstream from the fixing nip region N in the sheet conveyance direction and includes a guide face 42a having a curved surface. The guide face 42a may have an entirely curved surface of an equal radius of curvature or may have a plurality of curved surfaces of different radiuses of curvature. Further, the guide face 42a may have a curved surface and a flat surface. Further, the fixing device exit guide 42 may be a movable guide to remove the recording sheet P when a paper jam occurs.

As illustrated in FIG. 3, when viewed from a direction of axial rotation of the pressure roller 182, a Y direction indicates the sheet conveyance direction at the exit of the fixing nip region N (point of origin O) and an X direction indicates a direction perpendicular to the Y direction. Based on the exit of the fixing nip region N (point of origin O) as a reference point, where the side (direction) to the fixing belt 181 is represented as a −X direction and the side (direction) to the pressure roller 182 is represented as a +X direction, the guide face 42a of the fixing device exit guide 42 is curved toward the −X direction.

Note that the sheet conveyance direction (Y direction) from the exit of the fixing nip region N (point of origin O) is a direction in which a thick paper is directed on the downstream side from the fixing nip region N in the sheet conveyance direction when the thick paper is held and stopped in the fixing nip region N while being pressed. The thick paper having a basis weight of 200 g/m² or more is, for example, OK Prince High Grade having a basis weight of 209.3 g/m², manufactured by Oji Paper Co., Ltd.

After the fixing nip region N, the leading end of the recording sheet P having a back-edge curl (curling in the −X direction) contacts the guide face 42a of the fixing device exit guide 42. The leading end of the recording sheet P in contact with the guide face 42a of the fixing device exit guide 42, the guide face 42a being curled toward the −X direction, is bent toward the −X direction while being guided by the guide face 42a in the −X direction. As a result, the recording sheet p is bent in the direction opposite the direction of bending of the back-edge curl. The leading edge of the recording sheet P is bent in the −X direction while being guided by the fixing device exit guide 42 and a guide face 43a of the non-image forming side guide 43. As illustrated in FIG. 2, while being bent in the −X direction (in other words, while a bending force is being applied), the recording sheet P passes a first position G1 that is located −15 mm from the exit of the fixing nip region N on the guide face 43a of the non-image forming side guide 43 in the −X direction and a second position G2 that is located −30 mm from the exit of the fixing nip region N on the guide face 43a of the non-image forming side guide 43 in the −X direction. After passing the first position G1 and the second position G2, the back-edge curl of the recording sheet P is corrected.

In order to correct the back-edge curl of the recording sheet P, prior to generation of a back-edge curl, the bending force in the opposite direction is applied to stretch the fiber of the recording sheet P that is about to shrink. By so doing, the curl is corrected reliably. To be more specific, even though evaporation of water in the toner on the recording sheet P starts immediately after passing through the fixing nip region N of the fixing device 18, water still remains on the recording sheet P immediately after the fixing device 18. In that state, the fibers of the recording sheet P are loosely bound to each other, so that the fibers of the recording sheet P tend to stretch easily. Thus, when the fibers of the recording sheet P are loosely bound, the recording sheet P is bent to stretch the fibers of the recording sheet P sufficiently. Under these conditions, the fibers of the recording sheet P are shrunk and fixed due to evaporation of water in the recording sheet P, thereby increasing an efficacy of correcting curl of a recording sheet. As described above, while the fibers of the recording sheet P are loosely bound, the recording sheet P is bent to stretch the fibers of the recording sheet P sufficiently. As a result, water in the recording sheet P is evaporated, fixing the recording sheet P. Accordingly, the degree of shrinkage on the back face of the recording sheet P is reduced, and therefore increasing the efficacy of correcting curl of the recording sheet P. Therefore, it is preferable that the decurling mechanism 40 bends the recording sheet P with the decurling guide 47 (including the fixing device exit guide 42 and the non-image forming side guide 43) in a short time after passing the fixing nip region N, so as to correct the curl of the recording sheet P.

In the present embodiment, a position G1y represents a position of the first position G1 from the exit of the fixing nip region N (point of origin O) in the Y direction at a point of −15 mm (i.e., X=−15 mm) from the exit of the fixing nip region N (point of origin O) in the −X direction of the guide face of the decurling guide 47. As indicated in verification tests described below, it is preferable that the position G1y falls in a range from 15 mm to 25 mm. In other words, the position G1y is set to be 15 mm or more and 25 mm or less. When the position G1y in the Y direction for the first position G1 is less than 15 mm, the decurling guide 47 curves too sharp to guide the recording sheet P having the back-edge curl in the −X direction. As a result, paper jam occurs at the decurling guide 47. On the other hand, when the position G1y in the Y direction at the first position G1 is greater than 25 mm, a sufficient bending force is not applied to the recording sheet P by the decurling guide 47. Therefore, the decurling guide 47 fails to correct the back-edge curl of the recording sheet P sufficiently. By setting the position G1y in the Y direction at the first position G1 to be 15 mm or more and 25 mm less, preferably 15 mm or more and 20 mm or less, a recording sheet is conveyed properly and the back-edge curl of the recording sheet is corrected reliably.

Further, as indicated in the verification tests described below, a position G2y represents a position of the second position G2 from the exit of the fixing nip region (point of origin O) in the Y direction at a point of −30 mm (i.e., X=−30 mm) from the exit of the fixing nip region N (point of origin O) in the −X direction of the guide face of the decurling guide 47. As indicated in the verification tests described below, it is preferable that the position G2y falls in a range from 15 mm to 35 mm. In other words, the position G2y is set to be 15 mm or more and 35 mm or less. When the position G2y in the Y direction at the second position G2 is less than 15 mm, the trailing end of the recording sheet P that has passed through the fixing nip region contacts the ribs of the image forming side guide 44 hard, sliding on the ribs of the image forming side guide 44. Due to the sliding of the recording sheet P on the ribs of the image forming side guide 44, it is likely that the rib marks of the image forming side guide 44 are generated to remain at the trailing end of the image on the recording sheet P. In addition, the sheet ejecting position, at which the recording sheet P is ejected to the outside of the image forming apparatus 100, is lowered, resulting in a decrease in the number of recording sheets to be stacked in the sheet ejection tray 101a. If the position G2y in the Y direction at the second position G2 is greater than 35 mm, the efficacy of correcting the back-edge curl of the recording sheet P may decrease.

Accordingly, by setting the position G2y in the Y direction at the second position G2 to be 15 mm or more and 35 mm or less, preferably 15 mm or more and 25 mm or less, generation of the rib marks of the image forming side guide 44 is restrained and the back-edge curl of the recording sheet is corrected reliably.

Further, it is preferable that the minimum radius of curvature R of the guide face of the decurling guide 47 in the area in the +X direction from the first position G1 (in other words, in the area upstream from the first position G1 in the sheet conveyance direction; for example, X=−15 mm) is set to 15 mm or more and 30 mm or less. In a case in which the minimum radius of curvature R of the guide face of the decurling guide 47 in the region in the +X direction side from the first position G1 (upstream from the first position G1 in the sheet conveyance direction) is relatively small, a larger bending force is applied to the recording sheet with an unfixed back-edge curl, immediately after the recording sheet P has passed through the fixing nip region. Therefore, fixation of the back-edge curl of the recording sheet P is prevented, and the efficacy of correcting the curl is enhanced. However, the sheet conveying performance deteriorates, increasing the rate of occurrence of paper jam. Further, the image forming face of the recording sheet P that has passed through the fixing nip region hits (contacts) against the ribs of the image forming side guide 44 hard. Therefore, it is likely that the rib marks of the image forming side guide 44 are generated to remain in the image on the recording sheet P. In addition, the sheet ejecting position, at which the recording sheet P is ejected to the outside of the image forming apparatus 100, is lowered, resulting in a decrease in the number of recording sheets to be stacked in the sheet ejection tray 101a. On the other hand, when the minimum radius of curvature R of the guide face of the decurling guide 47 in the region in the +X direction side from the first position G1 (upstream from the first position G1 in the sheet conveyance direction) is relatively large, the bending force to be applied to the recording sheet is reduced, and therefore the efficacy of correcting the curl is degraded. Accordingly, by setting the minimum radius of curvature R to be 15 mm or more and 30 mm or less, the back-edge curl is corrected reliably, thereby restraining deterioration in the sheet conveying performance and the rib marks of the image forming side guide 44.

Further, θ1 depicted in FIG. 3 is a bending angle formed by a direction a of a tangent line of the guide face 43a of the non-image forming side guide 43 at the exit of the fixing device exit guide 42 in the sheet conveyance direction and the Y direction (in other words, the sheet conveyance direction at the exit of the fixing nip region). The bending angle θ1 is preferably 55 degrees or more and 70 degrees or less. As the bending angle becomes larger, the bending force to the recording sheet increases, and therefore the efficacy of correcting the curl of the recording sheet is enhanced. However, the sheet conveying performance and the rib marks of the image forming side guide 44 deteriorate as well as the minimum radius of curvature R. The number of recording sheets stacked in the sheet ejection tray 101a also decreases. On the other hand, if the bending angle θ1 is relatively small, the bending force to the recording sheet increases, resulting in a decrease in correction of the curl of a recording sheet. By setting the bending angle θ1 to 55 degrees or more and 70 degrees or less, the curl of a recording sheet is corrected reliably, and therefore deterioration of the sheet conveying performance and the rib marks of the image forming side guide 44 is restrained.

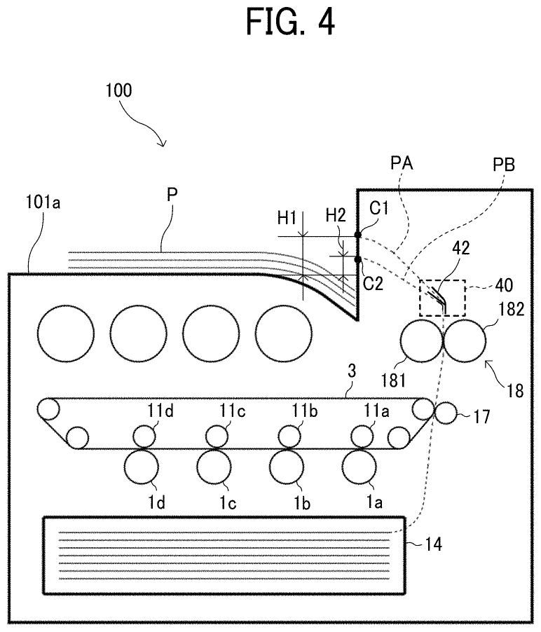

FIG. 4 is a diagram illustrating the image forming apparatus 100 indicating the relation of the minimum radius of curvature R of the guide face of the decurling guide 47 in the region in the +X direction side from the first position G1 (upstream from the first position G1 in the sheet conveyance direction) and the sheet ejecting position.

In FIG. 4, a sheet conveyance passage PA indicates a sheet ejection passage when the minimum radius of curvature R is relatively large and a sheet conveyance passage PB indicates a sheet conveyance passage when the minimum radius of curvature R is relatively small When the minimum radius of curvature R is relatively large, the recording sheet P is ejected from the inside to the outside of the image forming apparatus 100 to a sheet ejecting position C1 at a height H1 from (the top of) the sheet ejection tray 101a to the sheet ejecting position. By contrast, when the minimum radius of curvature R is relatively small, the recording sheet P is ejected to a sheet ejecting position C2 that is located lower than the sheet ejecting position C1. As a result, the recording sheet P is ejected to the sheet ejecting position C2 at a height H2 from (the top of) the sheet ejection tray 101a to the sheet ejecting position. Since the height H2 of the sheet ejecting position C2 is lower than the height H1 of the sheet ejecting position C1, the height of the sheet ejection tray 101a from (the top of) the sheet ejection tray 101a to the sheet ejecting position is lowered. Accordingly, the number of recording sheets stackable in the sheet ejection tray 101a is reduced.

Further, when the bending angle θ1 is relatively small, the sheet ejecting position rises, and therefore the height from (the top of) the sheet ejection tray 101a to the sheet ejecting position increases. As a result, the number of recording sheets stackable in the sheet ejection tray 101a increases. When the bending angle θ1 is relatively large, the sheet ejecting position lowers, and therefore the height from (the top of) the sheet ejection tray 101a to the sheet ejecting position decreases. As a result, the number of recording sheets stackable in the sheet ejection tray 101a reduces.

As for the position G2y in the Y direction of the second position G2 at the point of −30 mm in the X direction, when the position G2y is at a position away from the exit of the fixing nip region (point of origin O) in the Y direction, the sheet ejecting position is located higher, and therefore the height from (the top of) the sheet ejection tray 101a to the sheet ejecting position increases. As a result, the number of recording sheets stackable in the sheet ejection tray 101a increases. On the other hand, when the position G2y is at a position close to the exit of the fixing nip region (point of origin O) in the Y direction, the sheet ejecting position is located lower, and therefore the height from (the top of) the sheet ejection tray 101a to the sheet ejecting position decreases. As a result, the number of recording sheets stackable in the sheet ejection tray 101a reduces.

Further, the conveying speed (linear velocity) of a recording sheet is 150 mm/sec or more and 350 mm/sec or less. In other words, where the conveying speed of a recording sheet is represented as “V”, a relation of 150≤V 350≤is satisfied When the conveying speed V of the recording sheet P is less than 150 mm/sec, it takes a long time for the recording sheet P to pass the second position G2. Consequently, a large amount of water evaporates to fix the curl of the recording sheet P before the recording sheet P passes the second position G2, and the curl of the recording sheet P may not be corrected properly. On the other hand, when the conveying speed V of the recording sheet P is more than 350 mm/sec, the leading end of the recording sheet P having the back-edge curl contacts the guide face 42a of the fixing device exit guide 42. Due to the contact of the recording sheet P against the fixing device exit guide 42, the recording sheet P is not guided by the fixing device exit guide 42 properly, and therefore it is likely to increase occurrence of paper jam. By setting the conveying speed of the recording sheet P to 150 m/sec or more and 350 mm/sec or less, the curl (the back-edge curl) of the recording sheet P is corrected properly and deterioration of the sheet conveying performance is restrained.

Variation.

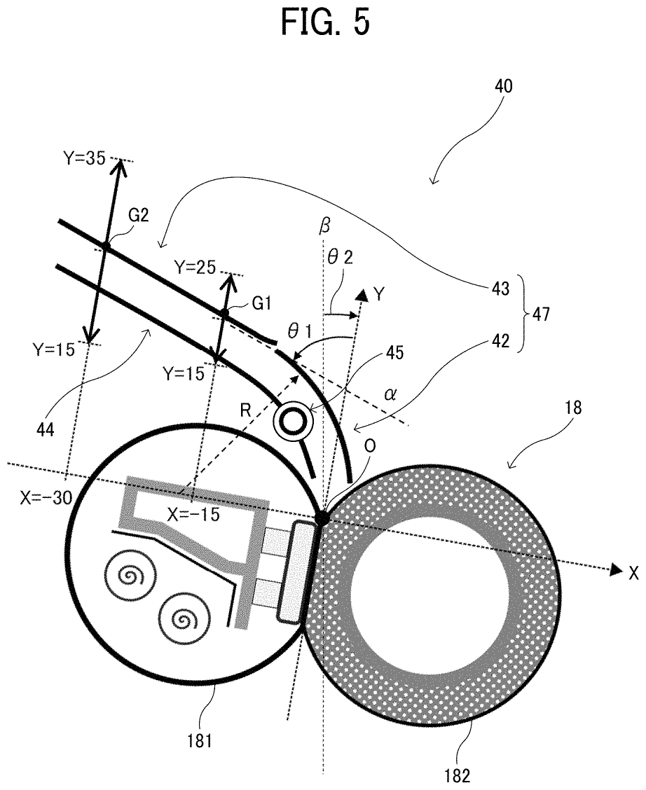

FIG. 5 is a diagram illustrating the fixing device 18 and the decurling mechanism 40 of the image forming apparatus 100 according to Variation of the present embodiment.

In Variation, the fixing device 18 and the decurling mechanism 40 are tilted at a given angle in the clockwise direction in FIG. 5, so that the Y direction, i.e., the sheet conveyance direction, at the exit of the fixing nip region is inclined relative to the vertical direction R of the ground contact surface of the image forming apparatus 100, in a direction to be away from the sheet ejection tray 101a. In other words, a relation of θ2>0 degree is satisfied, where θ2 is an angle of inclination of the Y direction (the sheet conveyance direction) at the exit of the fixing nip region relative to the vertical direction p of the ground contact surface of the image forming apparatus 100.

In this Variation, the sheet conveyance direction (the Y direction) at the exit of the fixing nip region is inclined relative to the vertical direction p of the ground contact surface of the image forming apparatus 100, in the direction away from the sheet ejection tray 101a.

According to this configuration, the sheet ejecting position of the recording sheet P from the inside to the outside of the image forming apparatus 100 is higher when compared with the configuration as illustrated in FIG. 3, in which the sheet conveyance direction (the Y direction) at the exit of the fixing nip region is vertical of the ground contact surface of the image forming apparatus 100 (i.e., the angle of inclination θ2=0 degree). Accordingly, the sheet stackability of the sheet ejection tray 101a is enhanced.

As the sheet conveyance direction at the exit of the fixing nip region, relative to the vertical direction of the ground contact surface of the image forming apparatus 100, is inclined, the recording sheet P that has been conveyed in the substantially vertical direction of the ground contact surface of the image forming apparatus 100 enters the fixing nip region while the recording sheet P is curved. Therefore, in a case in which the angle of inclination θ2 in the sheet conveyance direction at the exit of the fixing nip region N, relative to the vertical direction of the ground contact surface of the image forming apparatus 100 is too large, it is difficult for the recording sheet P to travel along the fixing device entrance guide properly. Consequently, the recording sheet P may not enter the fixing nip region N uniformly in the width direction, and therefore crease is likely to be generated in the recording sheet P.

For these reasons, there is an appropriate angle for the angle of inclination θ2. As described in the verification tests below, the angle of inclination θ2 is preferably set to 10 degrees or more and 20 degrees or less (i.e., a relation of 10 degrees≤θ2≤20 degrees). By so doing, when compared with the configuration illustrated in FIG. 3, the sheet stackability of the sheet ejection tray 101a is more enhanced and generation of creases in a recording sheet is restrained.

Next, a description of verification tests is given conducted by the applicant of this disclosure.

Verification Test 1.

Verification Test 1 was conducted with printers prepared by modifying MP C5504, a multifunction printer manufactured by Ricoh Company, Ltd. The modified printers are provided with the decurling mechanism 40 having the position in the Y direction of the first position G1, the position in the Y direction of the second position G2, the minimum radius of curvature R, and the bending angle θ1, which are different depending on embodiments and comparative examples. With each printer, image formation is performed at different conveying speeds (linear velocities) of a recording sheet to evaluate the amount of curling, the degree of rubbing on image, occurrence of paper jam, crease in the recording sheet, the sheet stackability of the sheet ejection tray 101a, and rib marks of the image forming side guide 44. The angle of inclination θ2 for Verification Test 1 is set to 0 degree.

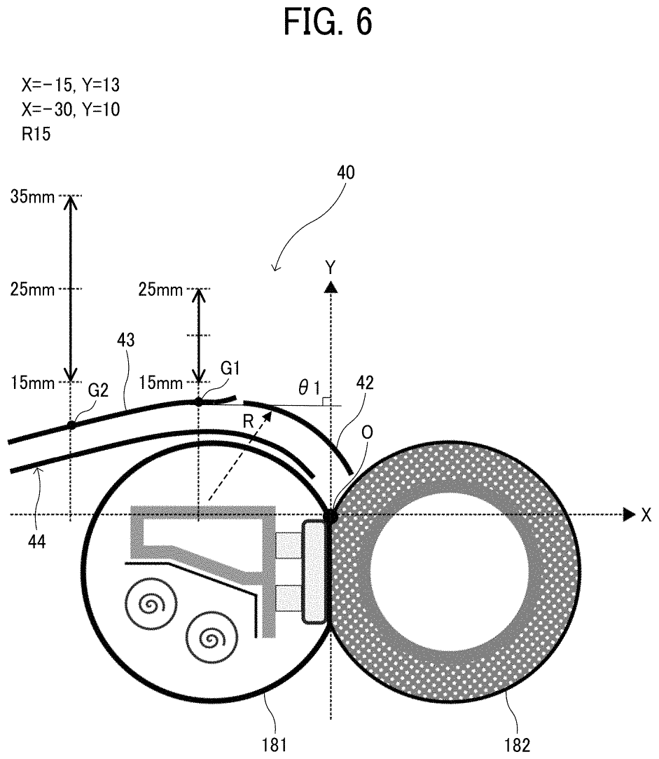

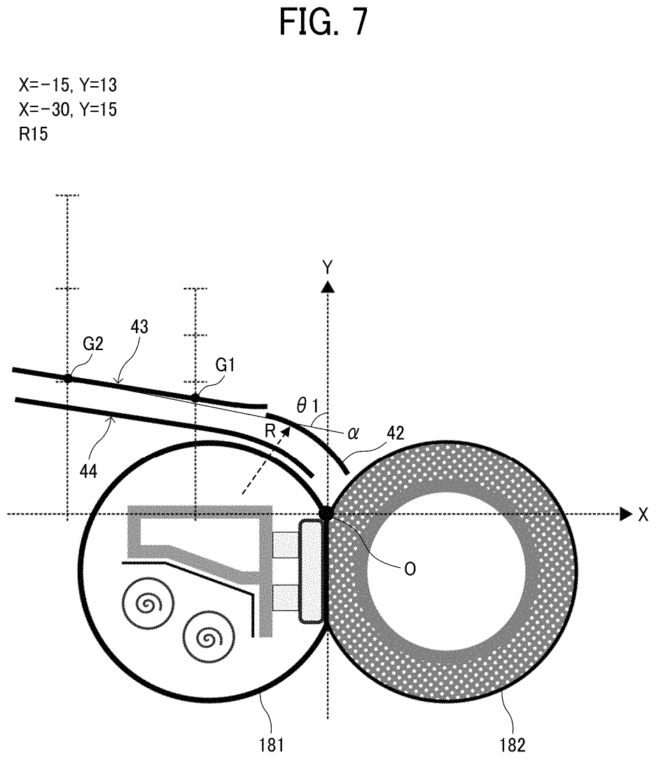

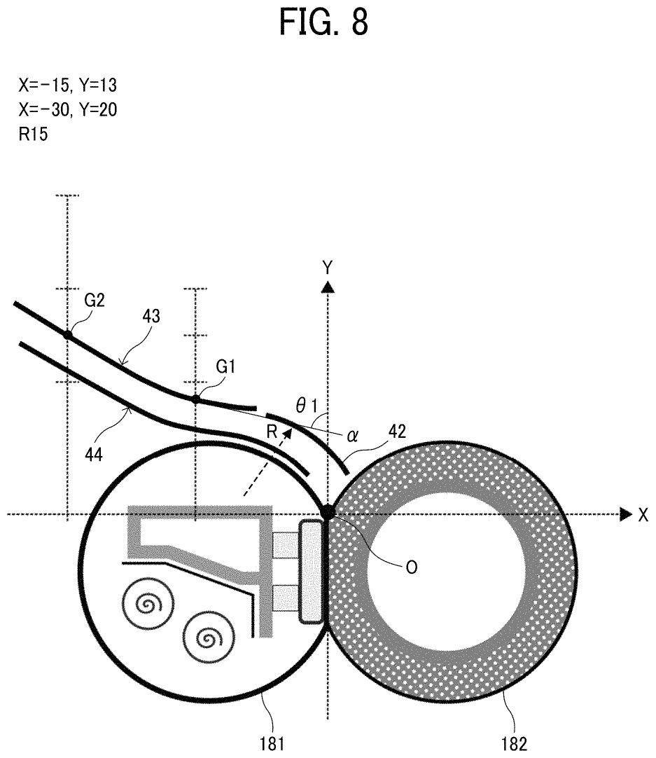

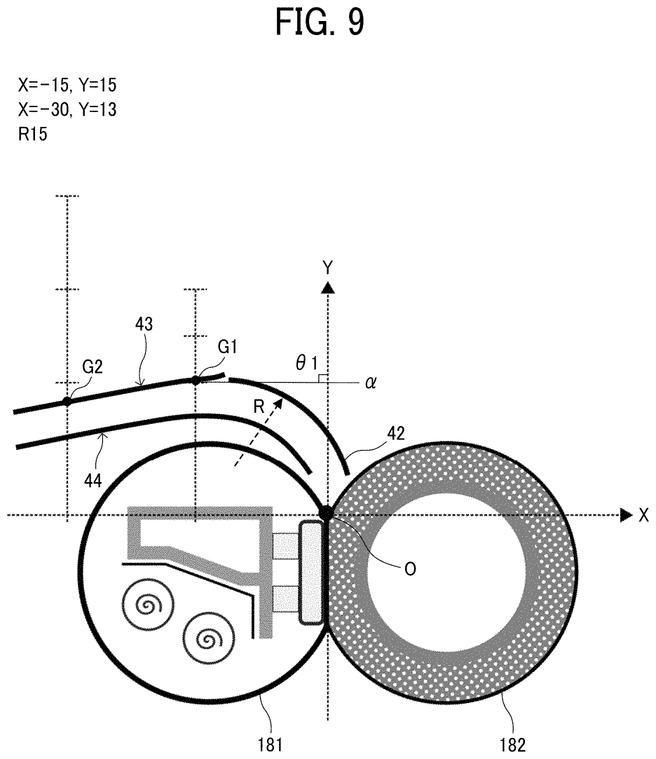

FIG. 6 is a diagram illustrating the main part of a printer for Comparative Example 1. FIG. 7 is a diagram illustrating the main part of a printer for Comparative Example 2. FIG. 8 is a diagram illustrating the main part of a printer for Comparative Example 3. FIG. 9 is a diagram illustrating the main part of a printer for Embodiments 1 to 4.

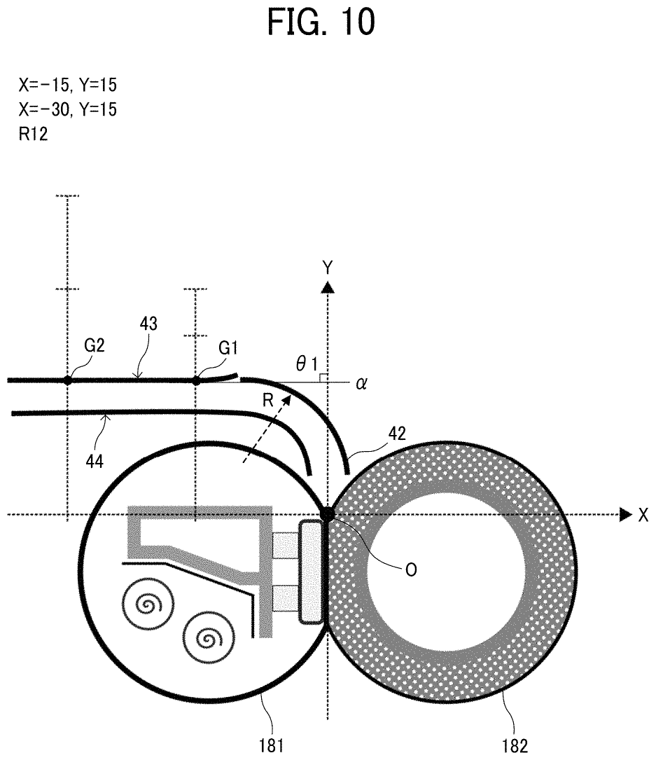

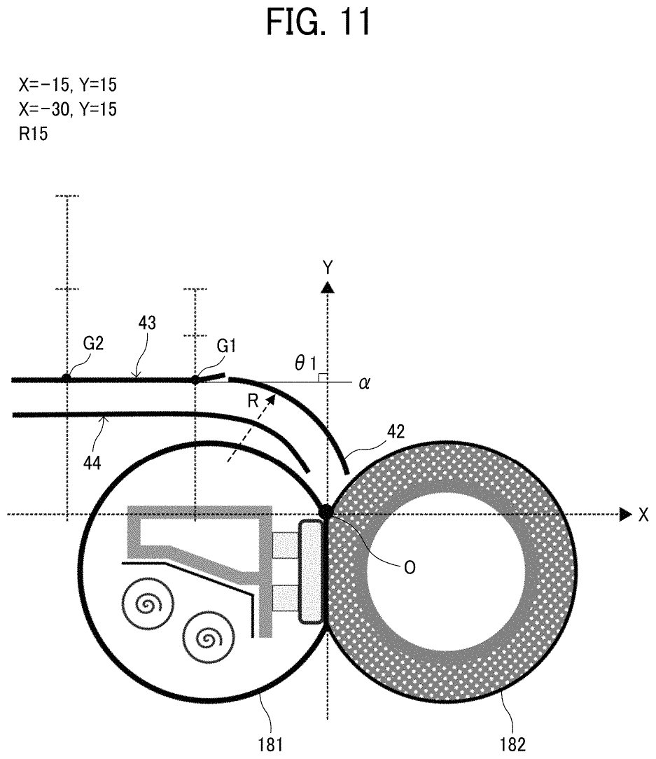

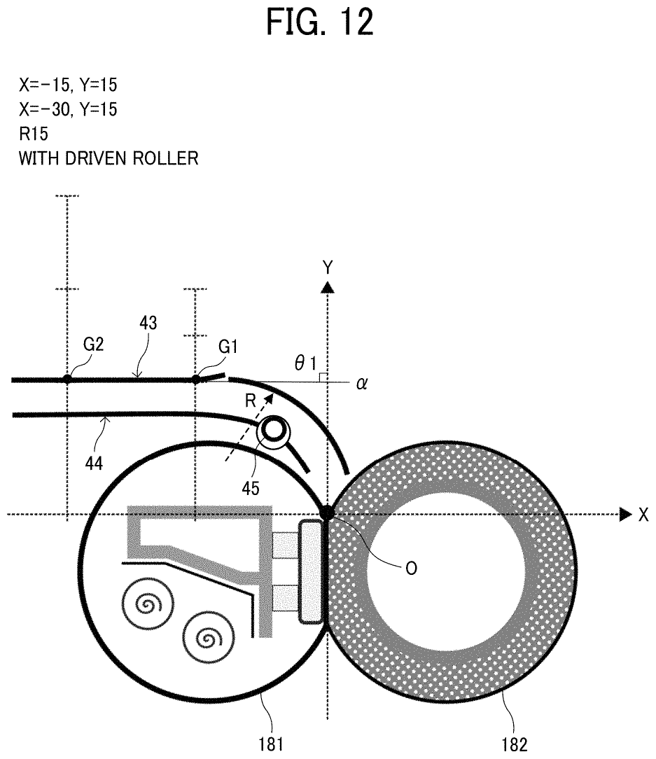

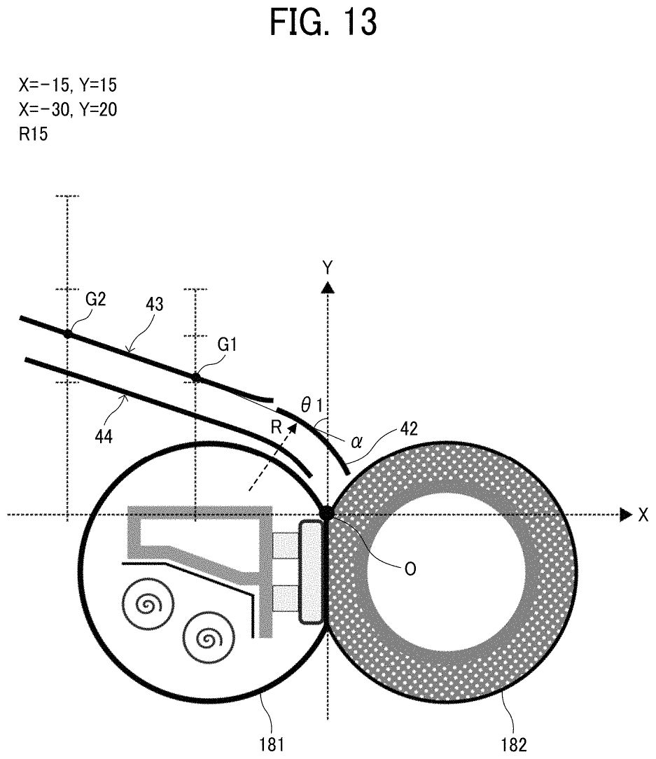

FIG. 10 is a diagram illustrating the main part of a printer for Embodiments 5 to 8. FIG. 11 is a diagram illustrating the main part of a printer for Embodiments 9 to 12. FIG. 12 is a diagram illustrating the main part of a printer for Embodiments 13 to 16. FIG. 13 is a diagram illustrating the main part of a printer for Embodiments 17 to 21.

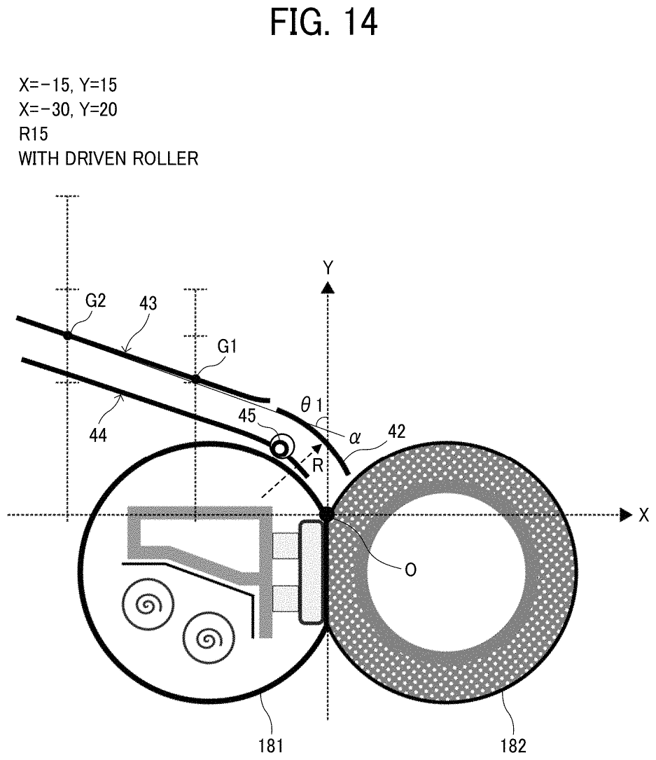

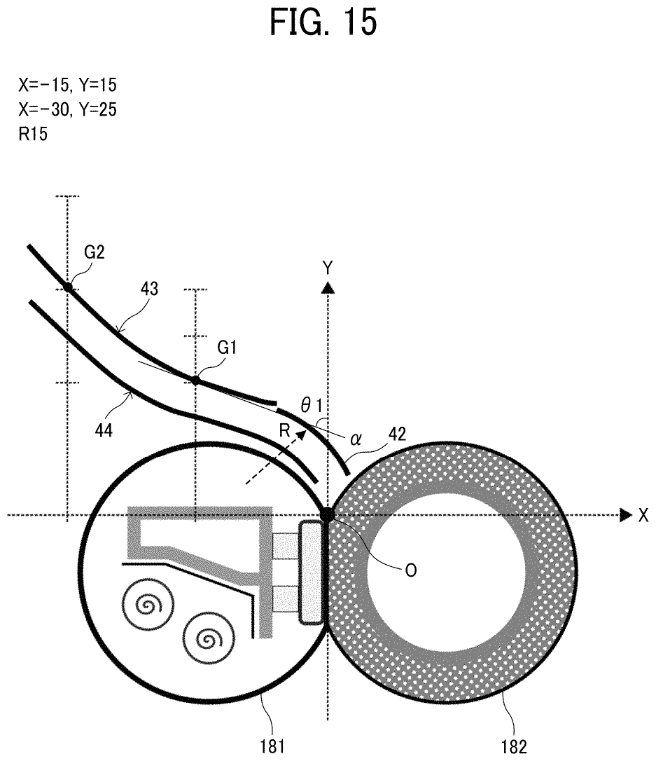

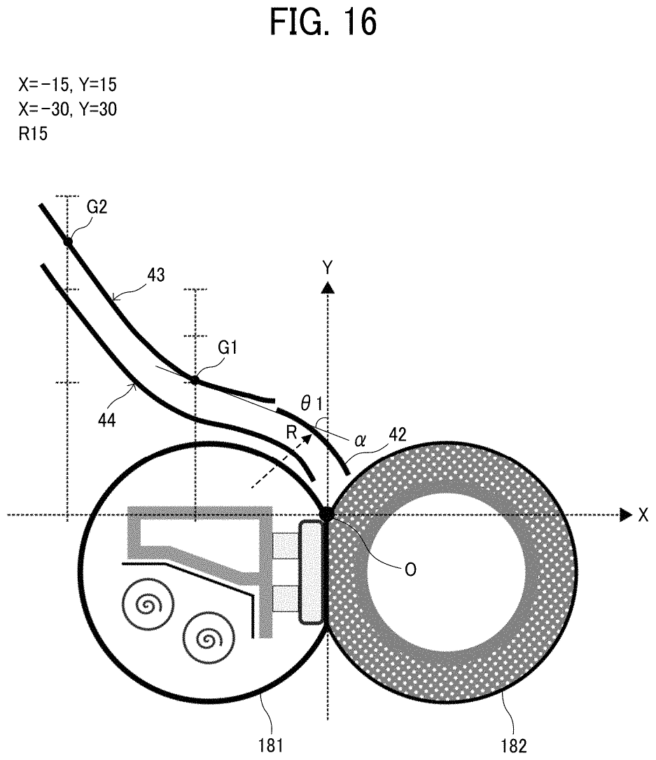

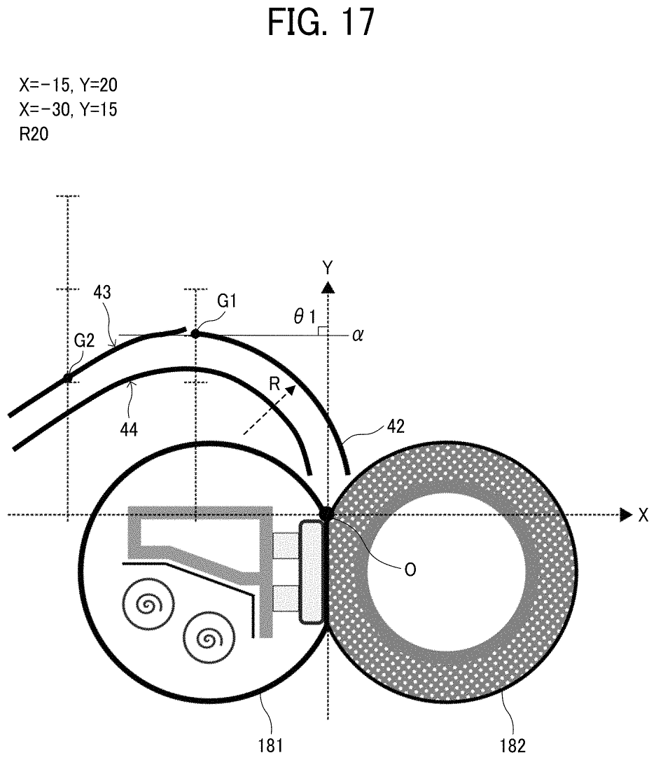

FIG. 14 is a diagram illustrating the main part of a printer for Embodiments 22 to 26. FIG. 15 is a diagram illustrating the main part of a printer for Embodiments 27 to 31. FIG. 16 is a diagram illustrating the main part of a printer for Embodiments 32 to 36. FIG. 17 is a diagram illustrating the main part of a printer for Embodiments 37 to 41.

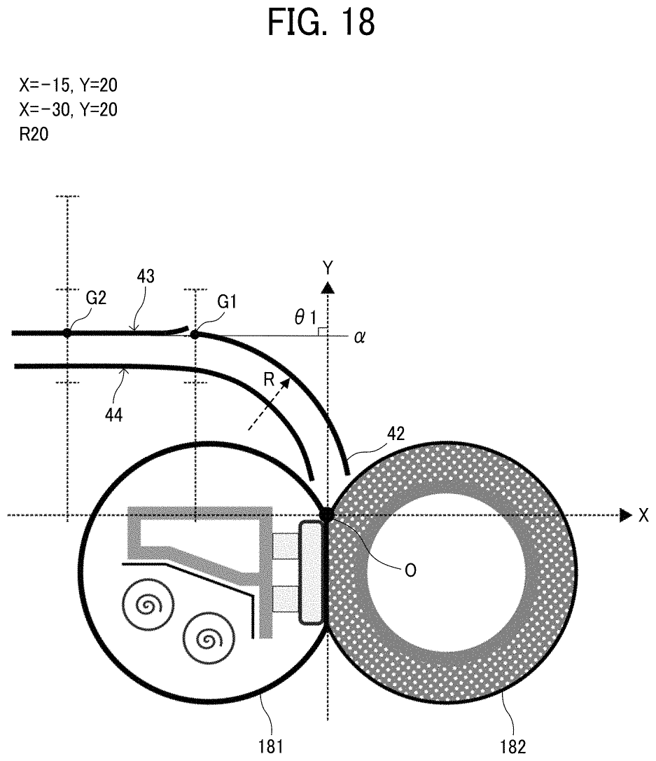

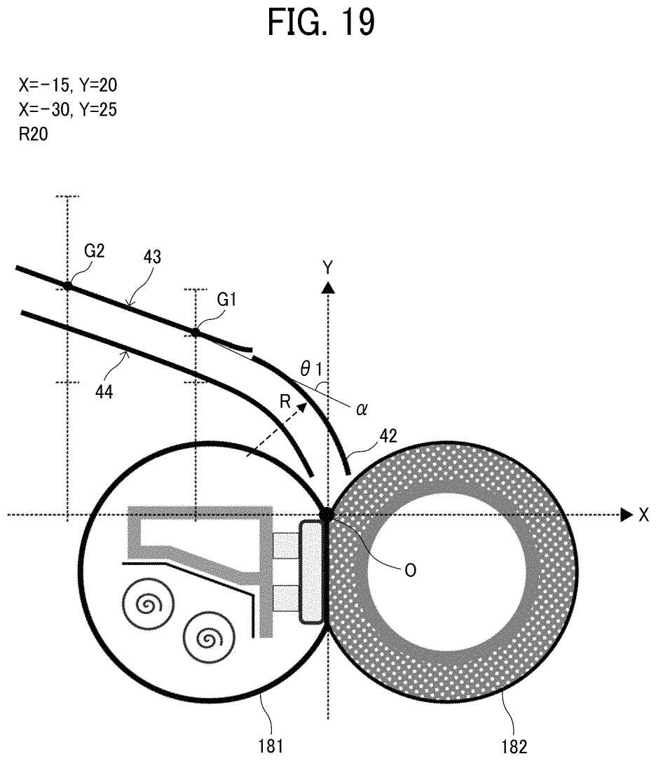

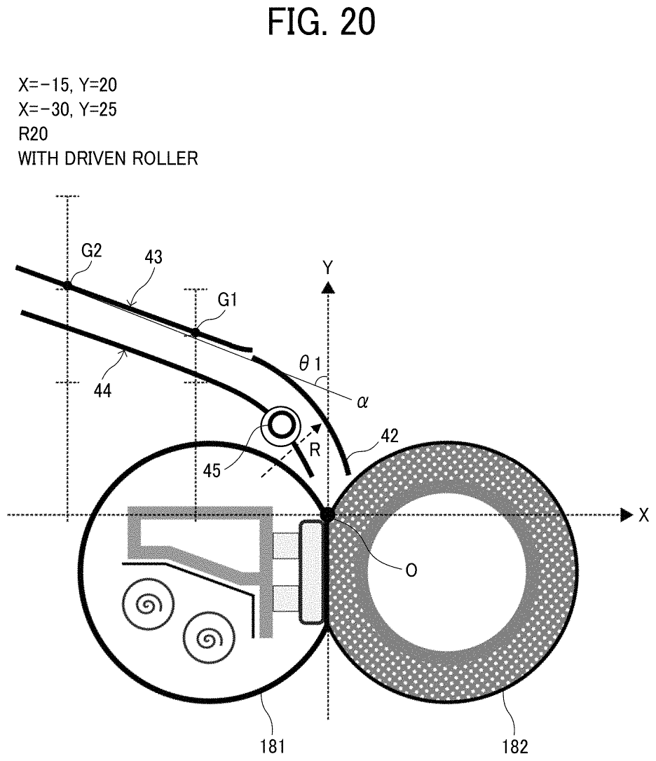

FIG. 18 is a diagram illustrating the main part of a printer for Embodiments 42 to 46. FIG. 19 is a diagram illustrating the main part of a printer for Embodiments 47 to 51. FIG. 20 is a diagram illustrating the main part of a printer for Embodiments 52 to 56.

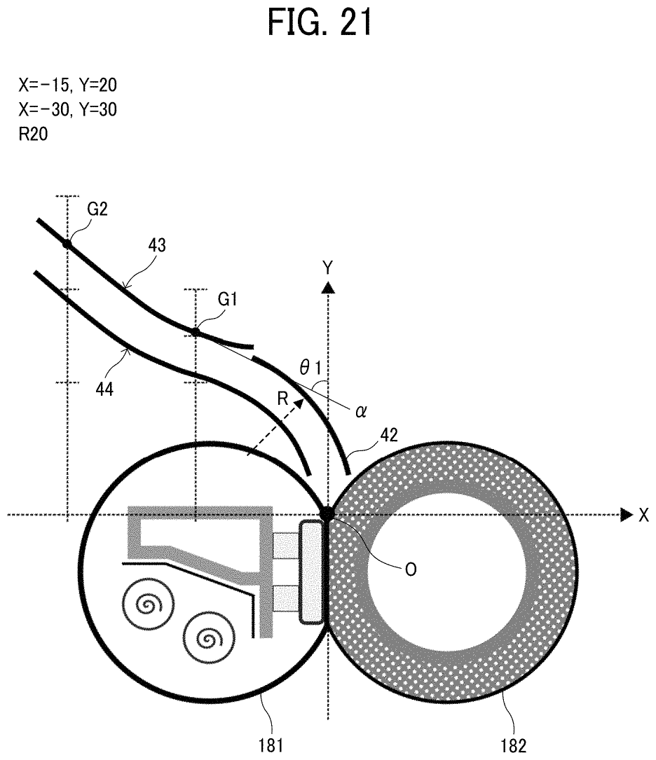

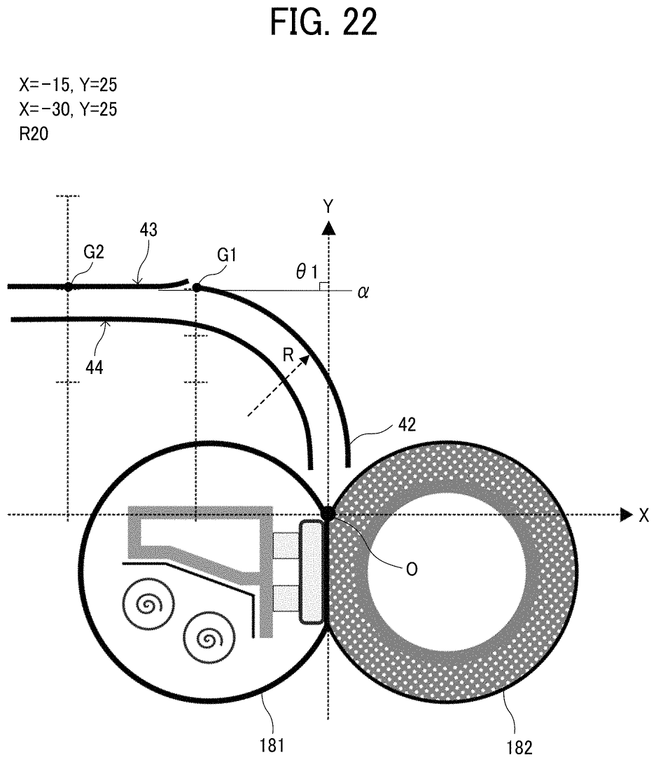

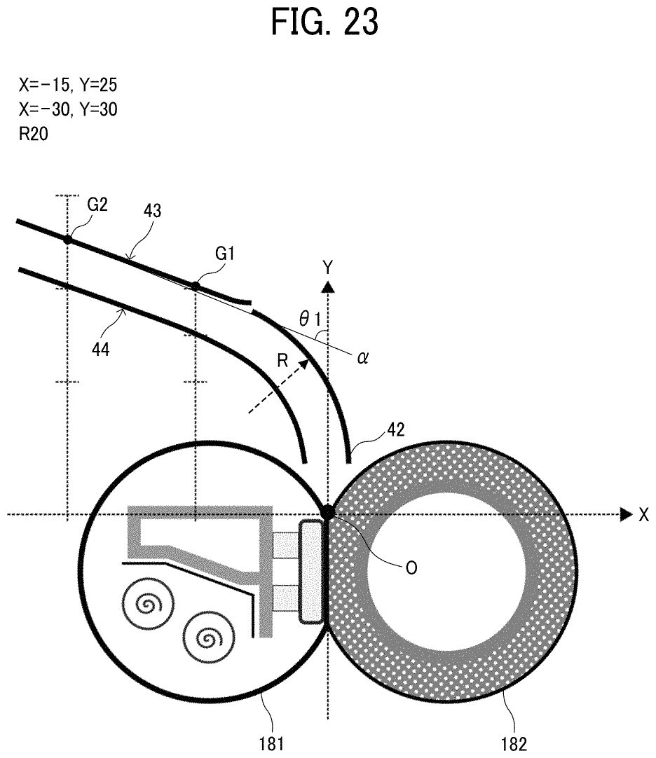

FIG. 21 is a diagram illustrating the main part of a printer for Embodiments 57 to 60. FIG. 22 is a diagram illustrating the main part of a printer for Embodiments 61 to 65. FIG. 23 is a diagram illustrating the main part of a printer for Embodiments 66 to 70.

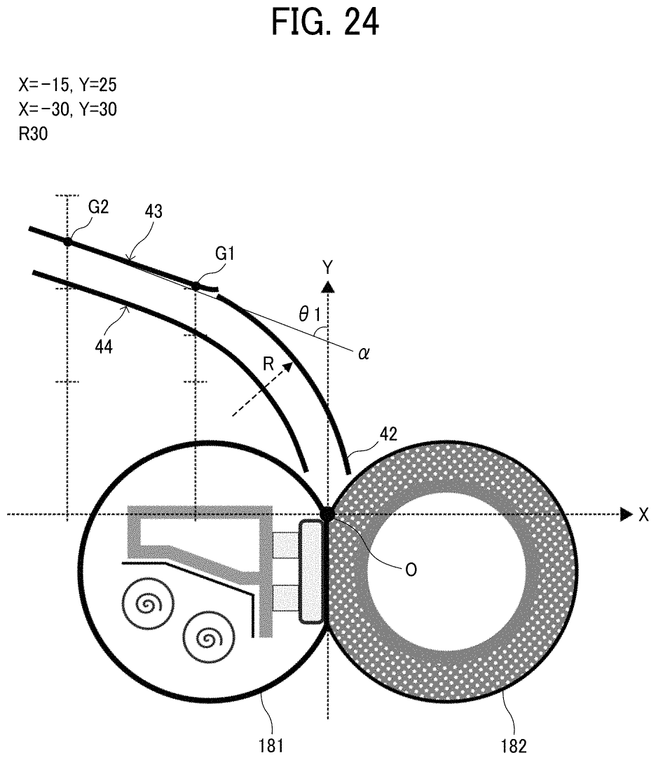

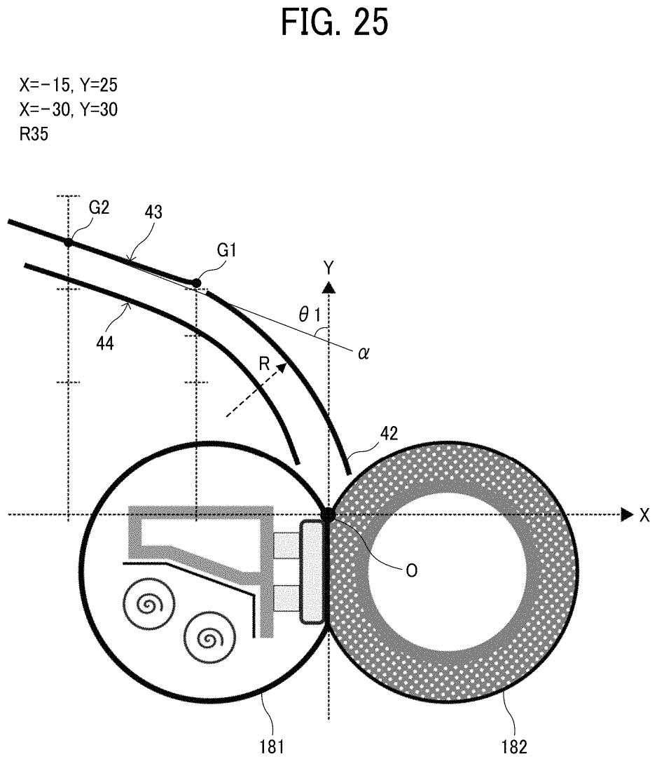

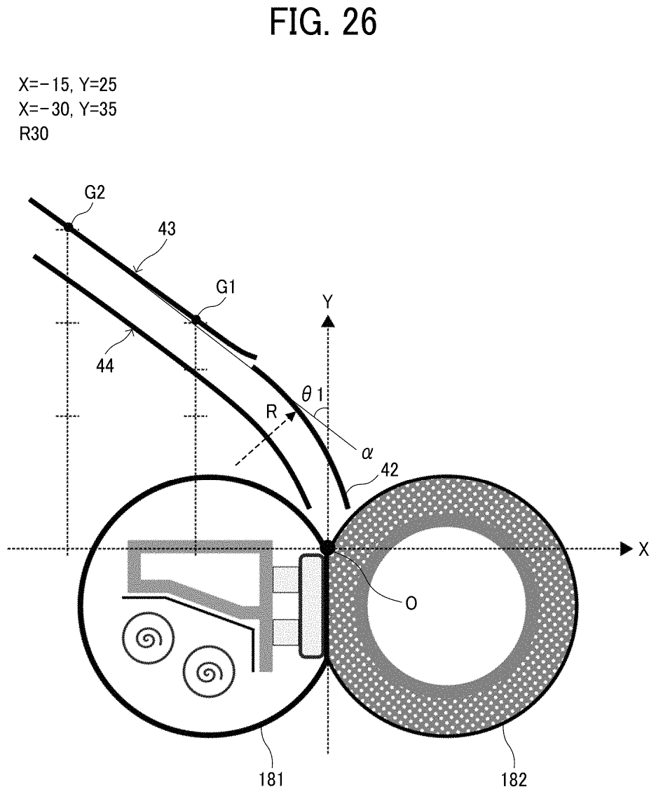

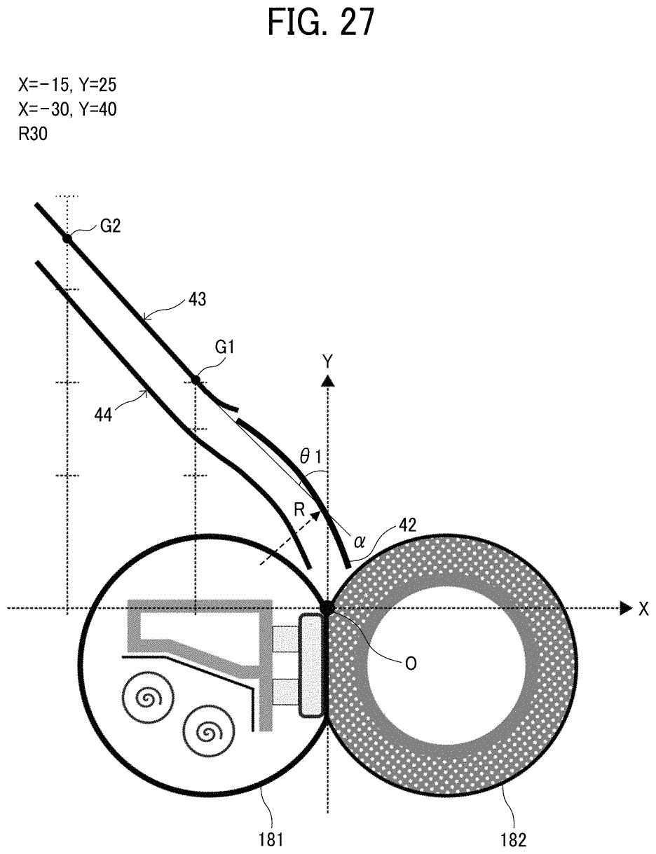

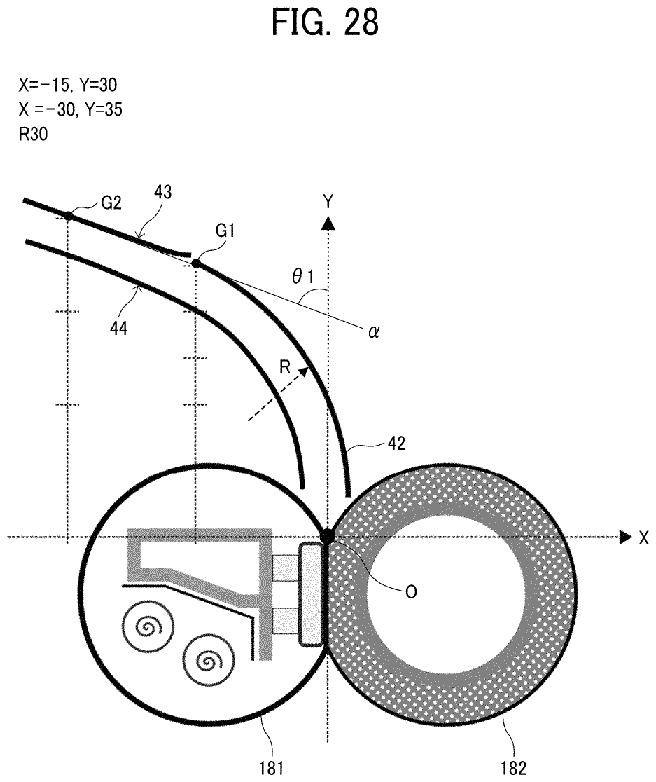

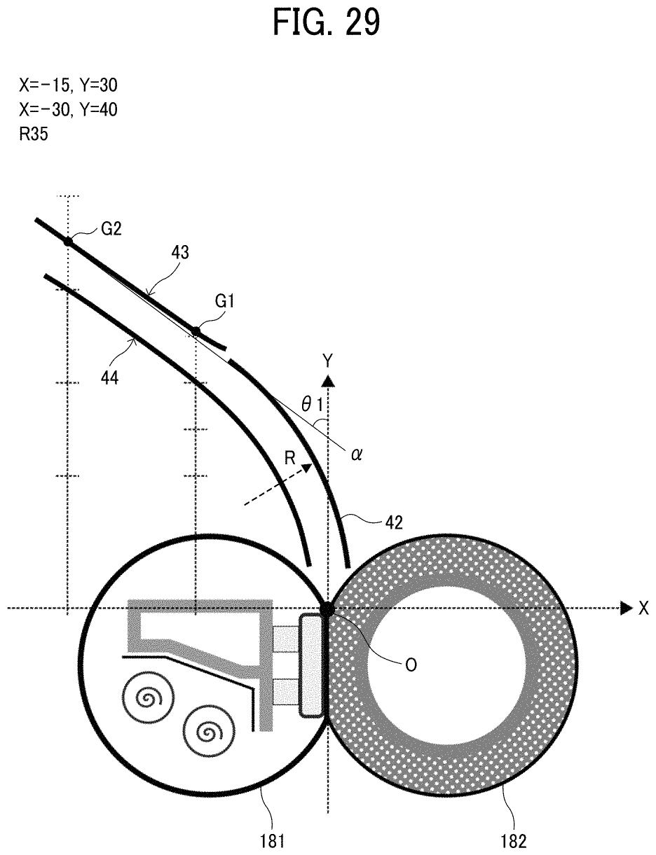

FIG. 24 is a diagram illustrating the main part of a printer for Embodiments 71 to 75. FIG. 25 is a diagram illustrating the main part of a printer for Embodiments 76 to 80. FIG. 26 is a diagram illustrating the main part of a printer for Embodiments 81 to 84. FIG. 27 is a diagram illustrating the main part of a printer for Embodiments 85 to 89. FIG. 28 is a diagram illustrating the main part of a printer for Comparative Example 4. FIG. 29 is a diagram illustrating the main part of a printer for Comparative Example 5.

Curling Amount Evaluation.

The amount of curling was evaluated as follows. For evaluating the amount of curling, 100 sheets of recycled plain paper copier (recycled PPC) papers manufactured by Oji Paper Co., Ltd. were bundled in a unit of 10 sheets, loaded on a humid control shelf, and left in an environment of a temperature of 27 degrees Celsius (° C.) and a humidity of 80% for three (3) days. After 10 sheets of recycled PPC papers were continuously printed, the printed 10 sheets were aligned on a flat plate after being ejected. The heights of four corners of the bundle of the printed 10 sheets placed on the flat plate were measured as respective amounts of curling, and the largest amount of the heights of the four corners is determined as the amount of curling. The criteria for determining the evaluation of the amount of curling (curling amount) are as described below:
Excellent: Curling Amount is less than 5 mm;
Very Good: Curling Amount is 5 mm or more and less than 10 mm;
Good: Curling Amount is 10 mm or more and less than 20 mm;
Acceptable: Curling Amount is 20 mm or more and less than 30 mm; and
Poor: Curling Amount is 30 mm or more.

Paper Jam Evaluation.

For evaluating occurrence of paper jam, 100 sheets of recycled PPC paper manufactured by Oji Paper Co., Ltd. were bundled in a unit of 10 sheets, loaded on the humid control shelf, and left in the environment of a temperature of 27 degrees Celsius (° C.) and a humidity of 80% for three (3) days. After 10 sheets of recycled PPC papers were continuously printed, the sheet conveying performance (in other words, whether paper jam occurs or not) was evaluated.
Good: No paper jam occurred or no bending of the sheets;
Acceptable: Bending of the sheets occurred; and
Poor: Paper jam occurred.

Crease Evaluation.

For evaluating generation of creases in a recording sheet, printing sheets of 55K, A3 long grain paper manufactured by Ricoh Company, Ltd. were left in the environment of a temperature of 27 degrees Celsius (° C.) and a humidity of 80% for three (3) days. After 10 sheets of printing sheets were continuously printed, generation of creases was evaluated.
Good: There were no sheets having creases; and
Poor: There were sheets having creases.

Rib Mark Evaluation.

After sheets of My Paper printing paper manufactured by Ricoh Company, Ltd. were printed, generation of rib marks on the sheets was evaluated. The criteria for determining the evaluation of rib marks remaining on sheets are as described below.
Good: No rib marks were visually identified in the sheets;
Acceptable: Rib marks were slightly identified in the sheets; and
Poor: Rib marks were clearly identified in the sheets.

Sheet Stackability Evaluation.

The number of sheets of My Paper printing paper manufactured by Ricoh Company, Ltd. stackable on the sheet ejection tray was determined as described below.

Excellent+: 500 sheets or more were stackable;

Excellent: Up to 500 sheets were stackable;

Very Good: Up to 400 sheets were stackable;

Good: Up to 300 sheets were stackable;

Acceptable: Up to 200 sheets were stackable; and

Poor: Up to 100 sheets were stackable.

Tables 1 to 6 below represent the results of Verification Test 1. Note that “COM” represents “Comparative Example” and “EMB” represents “Embodiment.”

TABLE 1

| | | | Linear | Radius of | Bonding | | Angle of | | | | | | |
|---|---|---|---|---|---|---|---|---|---|---|---|---|---|
| | | | Velocity | Curvature | Angle | Driven | Indentation | Curling | Paper | Rib | | | |
| | Gly | [symbol] | [symbol] | [symbol] | [symbol] | Roller | [symbol] | Amount | Jam | Marks | Crease | Stackability | FIG No. |
| DOM 1 | 15 | 10 | 250 | 15 | 90 | NO | 0 | — | Poor | — | — | — | [symbol] |
| DOM 2 | 15 | 15 | 250 | 15 | 90 | NO | 0 | — | Poor | — | — | — | 7 |
| DOM 3 | 15 | 20 | 250 | 15 | 90 | NO | 0 | — | Poor | — | — | — | [symbol] |
| EMB 1 | 15 | 15 | 100 | 15 | 90 | NO | 0 | Very Good | Good | Poor | Good | Poor | [symbol] |
| EMB 2 | 15 | 15 | 100 | 15 | 90 | NO | 0 | Very Good | Acceptable | Poor | Good | Poor | [symbol] |
| EMB 3 | 15 | 15 | 350 | 12 | 90 | NO | 0 | Very Good | Acceptable | Poor | Good | Poor | [symbol] |
| EMB 4 | 15 | 15 | 400 | 12 | 90 | NO | 0 | — | Poor | — | — | — | [symbol] |
| EMB 5 | 15 | 15 | 100 | 12 | 90 | NO | 0 | Very Good | Good | Poor | Good | Acceptable | 10 |
| EMB 6 | 15 | 15 | 150 | 12 | 90 | NO | 0 | Very Good | Acceptable | Poor | Good | Acceptable | 10 |
| EMB 7 | 15 | 15 | 350 | 15 | 90 | NO | 0 | Very Good | Acceptable | Poor | Good | Acceptable | 10 |
| EMB 8 | 15 | 15 | 400 | 15 | 90 | NO | 0 | — | Poor | — | — | — | 10 |
| EMB 9 | 15 | 15 | 100 | 15 | 90 | NO | 0 | Very Good | Good | Acceptable | Good | Acceptable | 11 |
| EMB 10 | 15 | 15 | 150 | 15 | 90 | NO | 0 | Very Good | Acceptable | Acceptable | Good | Acceptable | 11 |
| EMB 11 | 15 | 15 | 150 | 15 | 90 | NO | 0 | Very Good | Acceptable | Acceptable | Good | Acceptable | 11 |
| EMB 12 | 15 | 15 | 400 | 15 | 90 | NO | 0 | — | Poor | — | — | — | 11 |

[symbol]

indicates data missing or illegible when filed

TABLE 2

| | | | Linear | Radius of | Bonding | | Angle of | | | | | | |
|---|---|---|---|---|---|---|---|---|---|---|---|---|---|
| | | | Velocity | Curvature | Angle | Driven | Indentation | Curling | Paper | Rib | | | |
| | Gly | [symbol] | [symbol] | [symbol] | [symbol] | Roller | [symbol] | Amount | Jam | Marks | Crease | Stackability | FIG No. |
| EMB 13 | 15 | 15 | 100 | 15 | 90 | Provided | 0 | Very Good | Acceptable | Good | Good | Acceptable | 12 |
| EMB 14 | 15 | 15 | 180 | 15 | 90 | Provided | 0 | Very Good | Acceptable | Good | Good | Acceptable | 12 |
| EMB 15 | 15 | 15 | 300 | 15 | 90 | Provided | 0 | Very Good | Acceptable | Good | Good | Acceptable | 12 |
| EMB 16 | 15 | 15 | 400 | 15 | 90 | Provided | 0 | — | Poor | — | — | — | 12 |
| EMB 17 | 15 | 20 | 100 | 15 | 70 | NO | 0 | Acceptable | Good | Acceptable | Good | Very Good | 13 |
| EMB 18 | 15 | 20 | 150 | 15 | 70 | NO | 0 | Good | Acceptable | Acceptable | Good | Very Good | 13 |
| EMB 19 | 15 | 20 | 250 | 15 | 70 | NO | 0 | Very Good | Acceptable | Acceptable | Good | Very Good | 13 |
| EMB 20 | 15 | 20 | 300 | 15 | 70 | NO | 0 | Very Good | Acceptable | Acceptable | Good | Very Good | 13 |
| EMB 21 | 15 | 20 | 400 | 15 | 70 | NO | 0 | — | Poor | — | — | — | 14 |
| EMB 22 | 15 | 20 | 100 | 15 | 70 | Provided | 0 | Acceptable | Good | Good | Good | Very Good | 14 |
| EMB 23 | 15 | 20 | 150 | 15 | 70 | Provided | 0 | Good | Acceptable | Good | Good | Very Good | 14 |
| EMB 24 | 15 | 20 | 250 | 15 | 70 | Provided | 0 | Very Good | Acceptable | Good | Good | Very Good | 14 |
| EMB 25 | 15 | 20 | 300 | 15 | 70 | Provided | 0 | Very Good | Acceptable | Good | Good | Very Good | 14 |
| EMB 26 | 15 | 20 | 400 | 15 | 70 | Provided | 0 | — | Poor | — | — | — | 14 |

[symbol]

indicates data missing or illegible when filed

TABLE 3

| | | | Linear | Radius of | Bonding | | Angle of | | | | | | |
|---|---|---|---|---|---|---|---|---|---|---|---|---|---|
| | | | Velocity | Curvature | Angle | Driven | Indentation | Curling | Paper | Rib | | | |
| | Gly | [symbol] | [symbol] | [symbol] | [symbol] | Roller | [symbol] | Amount | Jam | Marks | Crease | Stackability | FIG No. |
| EMB 27 | 15 | 25 | 100 | 15 | 70 | NO | 0 | Acceptable | Good | Acceptable | Good | Excellent [symbol] | 15 |
| EMB 28 | 15 | 25 | 150 | 15 | 70 | NO | 0 | Good | Acceptable | Acceptable | Good | Excellent [symbol] | 15 |
| EMB 29 | 15 | 25 | 200 | 15 | 70 | NO | 0 | Very Good | Acceptable | Acceptable | Good | Excellent [symbol] | 15 |
| EMB 30 | 15 | 25 | 300 | 15 | 70 | NO | 0 | Very Good | Acceptable | Acceptable | Good | Excellent [symbol] | 15 |
| EMB 31 | 15 | 25 | 400 | 15 | 70 | NO | 0 | — | Poor | — | — | — | 15 |
| EMB 32 | 15 | 30 | 100 | 15 | 70 | NO | 0 | Poor | Good | Poor | Good | Excellent [symbol] | 16 |
| EMB 33 | 15 | 30 | 150 | 15 | 70 | NO | 0 | Acceptable | Acceptable | Poor | Good | Excellent [symbol] | 16 |
| EMB 34 | 15 | 30 | 200 | 15 | 70 | NO | 0 | Good | Acceptable | Poor | Good | Excellent [symbol] | 16 |
| EMB 35 | 15 | 30 | 150 | 15 | 70 | NO | 0 | Good | Acceptable | Poor | Good | Excellent [symbol] | 16 |
| EMB 36 | 15 | 30 | 400 | 15 | 70 | NO | 0 | — | Poor | — | — | — | 16 |
| EMB 37 | 20 | 15 | 100 | 20 | 90 | NO | 0 | Good | Good | Poor | Good | Poor | 17 |
| EMB 38 | 20 | 15 | 150 | 20 | 90 | NO | 0 | Very Good | Good | Poor | Good | Poor | 17 |
| EMB 39 | 20 | 15 | 200 | 20 | 90 | NO | 0 | Very Good | Good | Poor | Good | Poor | 17 |
| EMB 40 | 20 | 15 | 350 | 20 | 90 | NO | 0 | Very Good | Good | Poor | Good | Poor | 17 |
| EMB 41 | 20 | 15 | 400 | 20 | 90 | NO | 0 | Very Good | Acceptable | Poor | Good | Poor | 17 |

[symbol]

indicates data missing or illegible when filed

TABLE 4

| | | | Linear | Radius of | Bonding | | Angle of | | | | | | |
|---|---|---|---|---|---|---|---|---|---|---|---|---|---|
| | | | Velocity | Curvature | Angle | Driven | Indentation | Curling | Paper | Rib | | | |
| | Gly | [symbol] | [symbol] | [symbol] | [symbol] | Roller | [symbol] | Amount | Jam | Marks | Crease | Stackability | FIG No. |
| EMB 42 | 20 | 20 | 100 | 20 | 90 | NO | 0 | Acceptable | Good | Acceptable | Good | Acceptable | 18 |
| EMB 43 | 20 | 20 | 150 | 20 | 90 | NO | 0 | Good | Good | Acceptable | Good | Acceptable | 18 |
| EMB 44 | 20 | 20 | 200 | 20 | 90 | NO | 0 | Very Good | Good | Acceptable | Good | Acceptable | 18 |
| EMB 45 | 20 | 20 | 300 | 20 | 90 | NO | 0 | Very Good | Good | Acceptable | Good | Acceptable | 18 |
| EMB 46 | 20 | 20 | 400 | 20 | 90 | NO | 0 | Very Good | Acceptable | Poor | Good | Acceptable | 18 |
| EMB 47 | 20 | 20 | 100 | 20 | 70 | NO | 0 | Acceptable | Good | Acceptable | Good | Very Good | 19 |
| EMB 48 | 20 | 20 | 150 | 20 | 70 | NO | 0 | Good | Good | Acceptable | Good | Very Good | 19 |
| EMB 49 | 20 | 25 | 200 | 20 | 70 | NO | 0 | Very Good | Good | Acceptable | Good | Very Good | 19 |
| EMB 50 | 20 | 25 | 350 | 20 | 70 | NO | 0 | Very Good | Good | Acceptable | Good | Very Good | 19 |
| EMB 51 | 20 | 25 | 400 | 20 | 70 | NO | 0 | Very Good | Acceptable | Poor | Good | Very Good | 19 |
| EMB 52 | 20 | 25 | 100 | 20 | 70 | Provided | 0 | Acceptable | Good | Good | Good | Very Good | 20 |
| EMB 53 | 20 | 25 | 150 | 20 | 70 | Provided | 0 | Good | Good | Good | Good | Very Good | 20 |
| EMB 54 | 20 | 25 | 200 | 20 | 70 | Provided | 0 | Very Good | Good | Good | Good | Very Good | 20 |
| EMB 55 | 20 | 25 | 350 | 20 | 70 | Provided | 0 | Very Good | Good | Good | Good | Very Good | 20 |
| EMB 56 | 20 | 25 | 400 | 20 | 70 | Provided | 0 | Very Good | Acceptable | Good | Good | Very Good | 20 |

[symbol]

indicates data missing or illegible when filed

TABLE 5

| | | | Linear | Radius of | Bonding | | Angle of | | | | | | |
|---|---|---|---|---|---|---|---|---|---|---|---|---|---|
| | | | Velocity | Curvature | Angle | Driven | Indentation | Curling | Paper | Rib | | | |
| | Gly | [symbol] | [symbol] | [symbol] | [symbol] | Roller | [symbol] | Amount | Jam | Marks | Crease | Stackability | FIG No. |
| EMB 57 | 20 | 30 | 100 | 20 | 70 | NO | 0 | Acceptable | Good | Acceptable | Good | Excellent [symbol] | 21 |
| EMB 58 | 20 | 30 | 150 | 20 | 70 | NO | 0 | Good | Good | Acceptable | Good | Excellent [symbol] | 21 |
| EMB 59 | 20 | 30 | 300 | 20 | 70 | NO | 0 | Good | Good | Acceptable | Good | Excellent [symbol] | 21 |
| EMB 60 | 20 | 30 | 400 | 20 | 70 | NO | 0 | Good | Acceptable | Poor | Good | Excellent [symbol] | 21 |
| EMB 61 | 25 | 25 | 100 | 20 | 90 | NO | 0 | Poor | Good | Acceptable | Good | Good | 22 |
| EMB 62 | 25 | 25 | 150 | 20 | 90 | NO | 0 | Acceptable | Good | Acceptable | Good | Good | 22 |
| EMB 63 | 25 | 25 | 200 | 20 | 90 | NO | 0 | Good | Good | Acceptable | Good | Good | 22 |
| EMB 64 | 25 | 25 | 350 | 20 | 90 | NO | 0 | Good | Good | Acceptable | Good | Good | 22 |
| EMB 65 | 25 | 25 | 400 | 20 | 90 | NO | 0 | Good | Acceptable | Poor | Good | Good | 22 |
| EMB 66 | 25 | 30 | 100 | 20 | 70 | NO | 0 | Poor | Good | Acceptable | Good | Excellent | 23 |
| EMB 67 | 25 | 30 | 150 | 20 | 70 | NO | 0 | Acceptable | Good | Acceptable | Good | Excellent | 23 |
| EMB 68 | 25 | 30 | 200 | 20 | 70 | NO | 0 | Good | Good | Acceptable | Good | Excellent | 23 |
| EMB 69 | 25 | 30 | 350 | 20 | 70 | NO | 0 | Good | Good | Acceptable | Good | Excellent | 23 |
| EMB 70 | 25 | 30 | 400 | 20 | 70 | NO | 0 | Good | Acceptable | Poor | Good | Excellent | 23 |

[symbol]

indicates data missing or illegible when filed

TABLE 6

| | | | Linear | Radius of | Bonding | | Angle of | | | | | | |
|---|---|---|---|---|---|---|---|---|---|---|---|---|---|
| | | | Velocity | Curvature | Angle | Driven | Indentation | Curling | Paper | Rib | | | |
| | Gly | [symbol] | [symbol] | [symbol] | [symbol] | Roller | [symbol] | Amount | Jam | Marks | Crease | Stackability | FIG No. |
| EMB 71 | 25 | 30 | 100 | 30 | 70 | NO | 0 | Poor | Good | Acceptable | Good | Excellent | 24 |
| EMB 72 | 25 | 30 | 150 | 30 | 70 | NO | 0 | Acceptable | Good | Acceptable | Good | Excellent | 24 |
| EMB 73 | 25 | 30 | 200 | 30 | 70 | NO | 0 | Good | Good | Acceptable | Good | Excellent | 24 |
| EMB 74 | 25 | 30 | 350 | 30 | 70 | NO | 0 | Good | Good | Acceptable | Good | Excellent | 24 |
| EMB 75 | 25 | 30 | 400 | 30 | 70 | NO | 0 | Good | Acceptable | Poor | Good | Excellent | 24 |
| EMB 76 | 25 | 30 | 100 | 35 | 70 | NO | 0 | Poor | Good | Acceptable | Good | Excellent | 25 |
| EMB 77 | 25 | 30 | 150 | 35 | 70 | NO | 0 | Acceptable | Good | Acceptable | Good | Excellent | 25 |
| EMB 78 | 25 | 30 | 200 | 35 | 70 | NO | 0 | Acceptable | Good | Acceptable | Good | Excellent | 25 |
| EMB 79 | 25 | 30 | 350 | 35 | 70 | NO | 0 | Acceptable | Good | Acceptable | Good | Excellent | 25 |
| EMB 80 | 25 | 30 | 400 | 35 | 70 | NO | 0 | Acceptable | Acceptable | Poor | Good | Excellent | 25 |
| EMB 80 | 25 | 35 | 100 | 30 | 55 | NO | 0 | Poor | Good | Acceptable | Good | Excellent + | 25 |
| EMB 81 | 25 | 35 | 150 | 30 | 55 | NO | 0 | Acceptable | Good | Acceptable | Good | Excellent + | 25 |
| EMB 82 | 25 | 35 | 200 | 30 | 55 | NO | 0 | Good | Good | Acceptable | Good | Excellent + | 26 |
| EMB 83 | 25 | 35 | 350 | 30 | 55 | NO | 0 | Good | Good | Acceptable | Good | Excellent + | 26 |
| EMB 84 | 25 | 35 | 400 | 30 | 55 | NO | 0 | Good | Acceptable | Poor | Good | Excellent + | 26 |
| EMB 85 | 25 | 40 | 100 | 30 | 40 | NO | 0 | Poor | Good | Acceptable | Good | Excellent + | 27 |
| EMB 86 | 25 | 40 | 150 | 30 | 40 | NO | 0 | Acceptable | Good | Acceptable | Good | Excellent + | 27 |
| EMB 87 | 25 | 40 | 200 | 30 | 40 | NO | 0 | Acceptable | Good | Acceptable | Good | Excellent + | 27 |
| EMB 88 | 25 | 40 | 350 | 30 | 40 | NO | 0 | Acceptable | Good | Acceptable | Good | Excellent + | 27 |
| EMB 88 | 25 | 40 | 400 | 30 | 40 | NO | 0 | Acceptable | Good | Poor | Good | Excellent + | 27 |
| COM 4 | 30 | 35 | 250 | 30 | 70 | NO | 0 | Poor | Good | Acceptable | Good | Excellent | 28 |
| COM 5 | 30 | 40 | 250 | 35 | 55 | NO | 0 | Poor | Good | Acceptable | Good | Excellent + | 29 |

[symbol]

indicates data missing or illegible when filed

Table 1 represents the results of Verification Test 1 with the printer illustrated in FIGS. 6 to 11. Table 2 represents the results of Verification Test 1 with the printer illustrated in FIGS. 12 to 14. Table 3 represents the results of Verification Test 1 with the printer illustrated in FIGS. 15 to 17. Table 4 represents the results of Verification Test 1 with the printer illustrated in FIGS. 18 to 20. Table 5 represents the results of Verification Test 1 with the printer illustrated in FIGS. 21 to 23. Table 6 represents the results of Verification Test 1 with the printer illustrated in FIGS. 24 to 29.

As can be seen from Tables 1 to 6, in the curl amount evaluation, the embodiments, in which the conveying speed (linear velocity) of a recording sheet is 150 mm/sec or more and the position G1y in the Y direction of the first position G1 (X=−15 mm) on the guide face of the decurling guide 47 including the fixing device exit guide 42 and the non-image forming side guide 43 is represented as 15 mm≤G1y≤25 mm, were evaluated as “Acceptable” or better. Accordingly, the printers of the above-described embodiments corrected the curl of the recording sheet reliably. In particular, the embodiments, in which the conveying speed (linear velocity) of a recording sheet is 150 mm/sec or more and the position G1y in the Y direction of the first position G1 is represented as 15 mm≤G1y≤20 mm, were evaluated as “Good” or better, and therefore the printers of these embodiments corrected the curl of the recording sheet more reliably.

On the other hand, paper jam was confirmed in Comparative Examples 1 to 3, in which the position G1y in the Y direction of the first position G1 is 13 mm (see Table 1). Since the position G1y in the Y direction of the first position G1 is 13 mm, the position is close to the fixing nip region N. Therefore, as illustrated in FIGS. 6 to 8, the fixing device exit guide 42 is inclined largely toward the fixing belt 181, in other words, the angle of inclination toward the fixing belt 181 is relatively large. Therefore, it seems that the paper jam occurred because, when the leading end of the recording sheet having passed through the fixing nip region N with the back-edge curl contacted the guide face of the fixing device exit guide, the leading end of the recording sheet was not guided in the −X direction.

In Comparative Examples 4 and 5 in which the position G1y in the Y direction at the first position G1 was 30 mm, the curling amount was evaluated as “Poor” (see Table 6). Since the position G1y in the Y direction of the first position G1 is far from the fixing nip region N, as illustrated in FIGS. 28 and 29, the fixing device exit guide 42 near the fixing nip region N is inclined slightly toward the fixing belt 181, in other words, the angle of inclination toward the fixing belt 181 is relatively small. With this configuration, after the recording sheet has passed the fixing nip region, the leading end of the recording sheet contacts the guide face of the fixing device exit side guide at the position away from the fixing nip region N, thereby exerting the bending force. As a result, the bending force is applied to the recording sheet, from which water is evaporated to fix the curl of the recording sheet. Accordingly, the efficacy of correcting the curl of the recording sheet is reduced, and Comparative Example 4 illustrated in FIG. 28 and Comparative Example 5 illustrated in FIG. 29 were evaluated as “Poor.”

Further, in the embodiments having the conveying speed (linear velocity) of the recording sheet slower than the conveying speed (linear velocity) of the recording sheet (250 mm/sec) in Comparative Examples 4 and 5 and having severe conditions on the decurling (for example, Embodiments 82 and 83), the curling amount evaluation was resulted as “Acceptable” or better. Furthermore, similar to Comparative Examples 4 and 5, the embodiments having the conveying speed of the recording sheet less than 150 mm/sec (for example, Embodiments 32, 60, 66, 71, 76, 80, and 84) were evaluated as “Poor” in the curling amount. However, these embodiments were smaller in the curling amount than Comparative Examples 4 and 5 and were resulted in higher efficacy of correcting the curl of the recording sheet. From these results, it was confirmed that setting the position G1y in the Y direction of the first position G1 as 15 mm≤G1y≤25 mm enhances the efficacy of correcting the curl of the recording sheet.

As can be seen from Tables 1 to 6, the curling amount in Embodiments 85 to 89 in which the position G2y in the Y direction of the second position G2 is 40 mm is greater than the curling amount in the embodiments in which the position G2y in the Y direction of the second position G2 is 35 mm or smaller. As a result, the result of evaluation on the curling amount in Embodiments 85 to 89 was further lower. On the other hand, as is clear from comparison between the configuration of the printer of Embodiments 27 to 30 illustrated in FIG. 15 and the configuration of the printer of Embodiments 32 to 35 illustrated in FIG. 16, the curling amount in Embodiments 27 to 30 in which the position G2y in the Y direction of the second position G2 is 25 mm is smaller than the curling amount in Embodiments 32 to 35 in which the position G2y in the Y direction of the second position G2 is 30 mm. As a result, the result of evaluation on the curling amount in Embodiments 27 to 30 was further higher.

Further, the configuration of the printer of Embodiments 1 to 4 illustrated in FIG. 9, in which the position G2y in the Y direction of the second position G2 is 13 mm, was evaluated as “Poor” in the rib marks and sheet stackability. Since the orientation of conveyance of the recording sheet passing the second position G2 is the downward direction (−Y direction) in this configuration of the printer, the sheet stackability was resulted in “Poor.” Further, since the recording sheet is largely bent, the trailing side of the recording sheet after passing the fixing nip region comes closer to the image forming side guide 44. Therefore, the recording sheet hits hard and slides on the ribs of the image forming side guide 44. As a result, rib marks were clearly visible on the trailing side of the recording sheet, and therefore it is suggested that the evaluation on the rib marks was resulted in “Poor.”

From the results described above, the position G2y in the Y direction of the second position G2 is preferably 15 mm≤G2y≤35 mm, more preferably 15 mm≤G2y≤25 mm. In Embodiments 32 to 35 in which the result of the curling amount evaluation was low, the difference of the position G2y in the Y direction of the second position G2 and the position G1y in the Y direction of the first position G1 (in other words, the difference (G2y−G1y)), was 15 mm apart. On the other hand, in Embodiments 27 to 30 in which the result was higher in the curling amount evaluation than Embodiments 32 to 35, the difference (G2y−G1y) was 10 mm.

As is clear from comparison between the configuration of the printer of Embodiments 27 to 30 illustrated in FIG. 15 and the configuration of the printer of Embodiments 32 to 35 illustrated in FIG. 16, the slope of the sheet conveyance passage from the first position G1 to the second position G2 (in other words, the angle of inclination of the sheet conveyance passage relative to the horizontal direction) in Embodiments 32 to 35 is greater than the slope of the sheet conveyance passage in Embodiments 27 to 30.

Consequently, the sheet conveyance passage of Embodiments 32 to 35 has a greater S-shaped curve than the sheet conveyance passage of Embodiments 27 to 30. With the results, in Embodiments 32 to 35, the curl of the recording sheet was corrected (bent) toward the fixing device 18 at the fixing device exit guide 42 and then corrected toward the opposite direction (away from the fixing device 18) by the image forming side guide 44. This correction seems a factor of the low result in the curling amount evaluation. Accordingly, by setting the difference (G2y−G1y) to 10 mm or less, the degree of the S-shaped curve of the sheet conveyance passage is reduced, thereby restraining correction of the curl by the image forming side guide 44 toward the opposite direction to a decurling direction, at which the curl of the recording sheet is corrected, at the fixing device exit guide 42.

Further, as can be seen from comparison between the configuration of the printer of Embodiments 5 to 7 illustrated in FIG. 10 and the configuration of the printer of Embodiments 9 to 11 illustrated in FIG. 11, the minimum radius of curvature R of the guide face 42a of the fixing device exit guide 42, which is disposed upstream from the first position G1 in the sheet conveyance direction, is 12 mm in Embodiments 5 to 7 while the minimum radius of curvature R is 15 mm in Embodiments 9 to 11. Consequently, the configuration of the printer of Embodiments 5 to 7 received a lower result in the rib marks evaluation by one notch than the configuration of the printer of Embodiments 9 to 11. With this configuration, the curvature of the guide face of the decurling guide 47 near the exit of the fixing nip region N increases. As a result, as the recording sheet is conveyed to some extent after passing through the fixing nip region N, the recording sheet is brought toward the image forming side guide 44, so that the image forming side face of the recording sheet P hits hard and slides on the image forming side guide 44. As a result, rib marks were clearly visible on the trailing side of the recording sheet, and therefore it is conceived that the evaluation on the rib marks was resulted in “Poor.”

Further, as can be seen from comparison between the configuration of the printer of Embodiments 71 to 75 illustrated in FIG. 24 and the configuration of the printer of Embodiments 76 to 80 illustrated in FIG. 25, the configuration of the printer of Embodiments 76 to 80 in which the minimum radius of curvature R is 35 mm received a lower result in the curling amount evaluation than the configuration of the printer of Embodiments 71 to 75. In the configuration of the printer of Embodiment 76 to 80, the curvature of the guide face of the decurling guide 47 near the exit of the fixing nip region N is relatively small and the bending force to the recording sheet P is relatively low (small). Therefore, it seems that the effect of the decurling was reduced. From this result, it is preferable that the minimum radius of curvature R of the guide face of the decurling guide 47 upstream from the first position G1 in the sheet conveyance direction is set to 15 mm or more and 30 mm or less.

Further, it is preferable that the bending angle θ1 of the fixing device exit guide 42 is 55 degrees≤θ1≤70 degrees. When compared with the bending angle θ1 of 90 degrees, the rib marks and the sheet stackability were enhanced. Further, when compared with the bending angle θ1 of 40 degrees (e.g., Embodiments 85 to 89), it was confirmed that the curling amount was smaller to enhance the efficacy of correcting the curl.

In addition, when compared with Embodiments not provided with the driven roller 45, Embodiments 13 to 15, 22 to 25, and 52 to 56 provided with the driven roller 45 received better results in the rib marks evaluation. From this result, by providing the driven roller 45, it was confirmed that occurrence of rib marks was restrained.

It was also confirmed that, when the conveying speed (linear velocity) of a recording sheet is 150 mm/sec or more and 350 mm/sec or less, no paper jam occurred, and therefore the curl of the recording sheet is corrected reliably.

Verification Test 2.

Verification Test 2 was conducted to verify an optimum angle of the angle of inclination θ2 in Variation.

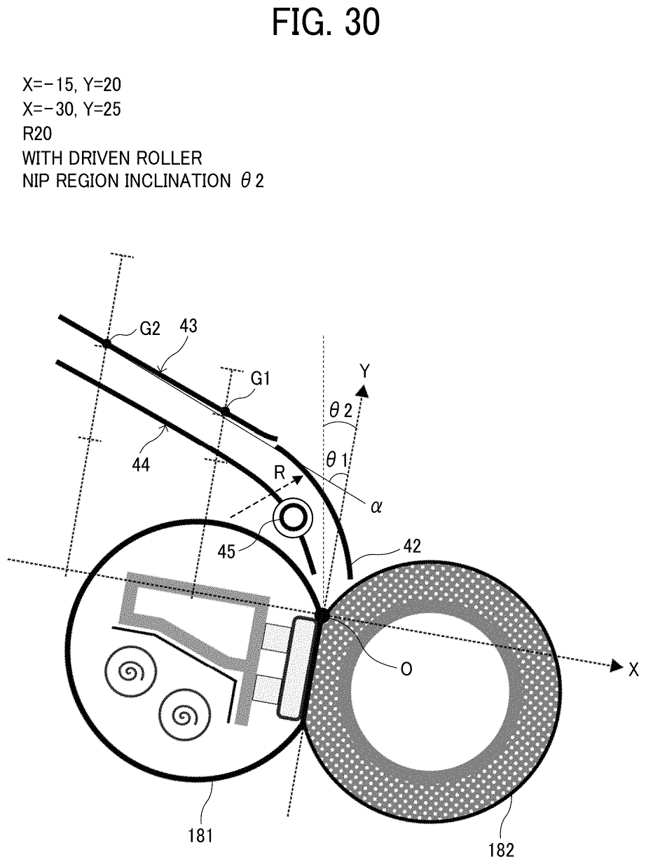

FIG. 30 is a diagram illustrating the main part of a printer used for Embodiments 90 to 106.

In Verification Test 2, the printer of Embodiments 43 to 47 illustrated in FIG. 20 used in Verification Test 1 was modified as described in Variation (see FIG. 30), so that the printer of FIG. 30 was set to have the angle of inclination θ2 to be different in a range from 10 degrees to 30 degrees, where the angle of inclination θ2 was angled in the sheet conveyance direction at the exit of the fixing nip region N, to the vertical direction of the ground contact surface of the printer. Further, as in Verification Test 1, the amount of curling, the degree of rubbing on image, occurrence of paper jam, crease in the recording sheet, rib marks on the recording sheet, and the sheet stackability of the sheet ejection tray 101a were evaluated. Verification Test 2 used the same evaluation method as the evaluation method of Verification Test 1.

Table 7 represents the results of Verification Test 2.

TABLE 7

| | | | Linear | Radius of | Bonding | | Angle of | | | | | | |
|---|---|---|---|---|---|---|---|---|---|---|---|---|---|
| | | | Velocity | Curvature | Angle | Driven | Indentation | Curling | Paper | Rib | | | |
| | Gly | [symbol] | [symbol] | [symbol] | [symbol] | Roller | [symbol] | Amount | Jam | Marks | Crease | Stackability | FIG No. |
| EMB 90 | 20 | 25 | 100 | 20 | 70 | Provided | 10 | Acceptable | Good | Good | Good | Excellent | 30 |
| EMB 91 | 20 | 25 | 150 | 20 | 70 | Provided | 10 | Good | Good | Good | Good | Excellent | 30 |
| EMB 92 | 20 | 25 | 200 | 20 | 70 | Provided | 10 | Very Good | Good | Good | Good | Excellent | 30 |
| EMB 93 | 20 | 25 | 350 | 20 | 70 | Provided | 10 | Very Good | Good | Good | Good | Excellent | 30 |
| EMB 94 | 20 | 25 | 400 | 20 | 70 | Provided | 10 | Very Good | Acceptable | Good | Acceptable | Excellent | 30 |
| EMB 95 | 20 | 25 | 100 | 20 | 70 | Provided | 20 | Acceptable | Good | Good | Good | Excellent + | 30 |
| EMB 96 | 20 | 25 | 150 | 20 | 70 | Provided | 20 | Good | Good | Good | Good | Excellent + | 30 |
| EMB 97 | 20 | 25 | 200 | 20 | 70 | Provided | 20 | Very Good | Good | Good | Good | Excellent + | 30 |
| EMB 98 | 20 | 25 | 350 | 20 | 70 | Provided | 20 | Very Good | Good | Good | Good | Excellent + | 30 |
| EMB 99 | 20 | 25 | 400 | 20 | 70 | Provided | 20 | Very Good | Acceptable | Good | Acceptable | Excellent + | 30 |
| EMB 100 | 20 | 25 | 100 | 20 | 70 | Provided | 30 | Acceptable | Good | Good | Poor | Excellent + | 30 |
| EMB 101 | 20 | 25 | 150 | 20 | 70 | Provided | 30 | Good | Good | Good | Poor | Excellent + | 30 |
| EMB 102 | 20 | 25 | 200 | 20 | 70 | Provided | 30 | Very Good | Good | Good | Poor | Excellent + | 30 |
| EMB 103 | 20 | 25 | 250 | 20 | 70 | Provided | 30 | Very Good | Good | Good | Poor | Excellent + | 30 |
| EMB 104 | 20 | 25 | 300 | 20 | 70 | Provided | 30 | Very Good | Good | Good | Poor | Excellent + | 30 |
| EMB 105 | 20 | 25 | 350 | 20 | 70 | Provided | 30 | Very Good | Good | Good | Poor | Excellent + | 30 |
| EMB 106 | 20 | 25 | 400 | 20 | 70 | Provided | 30 | Very Good | Acceptable | Good | Poor | Excellent + | 30 |

[symbol]

indicates data missing or illegible when filed

As indicated in Table 7, the sheet conveyance direction (the Y direction) at the exit of the fixing nip region N is inclined relative to the vertical direction p of the ground contact surface of the printer, in the direction away from the sheet ejection tray 101a. According to this configuration, the sheet stackability was significantly enhanced when compared with the configuration of the printer (e.g., Embodiments 43 to 47) in Verification Test 1 in which the sheet conveyance direction at the exit of the fixing nip region N is not inclined relative to the vertical direction of the ground contact surface of the printer. Accordingly, it was confirmed that a larger number of recording sheets is ejected to the sheet ejection tray 101a.

Further, in Embodiments 100 to 106 in which the sheet conveyance direction at the exit of the fixing nip region N is inclined by 30 degrees (θ2=30 degrees) relative to the vertical direction R of the ground contact surface of the printer, in the direction away from the sheet ejection tray 101a, there were recording sheets with creases. Therefore, the crease evaluation was resulted in “Poor.”

From Verification Test 2, it was found that the angle of inclination θ2, which is an angle of inclination of the sheet conveyance direction (the Y direction) at the exit of the fixing nip region N inclined relative to the vertical direction 1 of the ground contact surface of the printer, is preferably set to 10 degrees or more and 20 degrees of less.

The configurations according to the above-descried embodiments are not limited thereto. This disclosure achieves the following aspects effectively.

Aspect 1.

In Aspect 1, an image forming apparatus (for example, the image forming apparatus 100) includes an image forming device (for example, the photoconductors 1a, b, 1c, and 1d), a fixing device (for example, the fixing device 18), and a decurler (for example, the decurling mechanism 40). The image forming device is configured to form an image on a sheet (for example, the recording sheet P). The fixing device includes a heater (for example, the heaters 183), a rotary heat member (for example, the fixing belt 181) configured to be heated by the heater, and a rotary nip forming member (for example, the pressure roller 182) configured to contact the rotary heat member to form a fixing nip region (for example, the fixing nip region N). The fixing device is configured to pass the sheet with the image, through the fixing nip region in a sheet conveyance direction, in which the sheet is conveyed, to fix the image to the sheet. The decurler includes a decurling guide (for example, the decurling guide 47 including the fixing device exit guide 42 and the non-image forming side guide 43) configured to correct a curl of the sheet while guiding the sheet after the fixing device. The decurling guide has a guide face configured to face a surface of the sheet having contacted the rotary nip forming member in the fixing nip region. The decurling guide is configured to correct the curl of the sheet while guiding the sheet in a −X direction, where a downstream end of the fixing nip region in the sheet conveyance direction is a point of origin, the sheet conveyance direction at the point of origin is a Y direction, a direction perpendicular to the Y direction is an X direction, and a side toward the rotary nip forming member from the point of origin is a +X direction, and a direction opposite the +X direction is the −X direction, when the image forming apparatus is viewed from an axial direction of the rotary nip forming member. A relation of 15 mm≤G1y≤25 mm is satisfied, where G1y represents a position from the point of origin in the Y direction at a point of −15 mm from the point of origin in the X direction on a guide face of the decurling guide.

According to this configuration, as described in Verification Test 1 above, the curl of the sheet is corrected reliably without causing a paper jam.

Aspect 2.

In Aspect 1, wherein a relation of 15 mm≤G1y≤20 mm is satisfied.

According to this configuration, as described in Verification Test 1 above, the curling amount evaluation resulted in “Good” or better. Therefore, the curl of the sheet is corrected more reliably.

Aspect 3.

In Aspect 1 or Aspect 2, a relation of 150 mm/sec≤V≤350 mm/sec is satisfied, where V represents a conveying speed of the sheet.

According to this configuration, as described in Verification Test 1 above, the curl of the sheet is corrected reliably without causing a paper jam.

Aspect 4.

In any one of Aspects 1 to 3, a relation of 15 mm≤G2y≤35 mm is satisfied, where G2y represents a position from the point of origin in the Y direction at a point of −30 mm from the point of origin in the X direction on the guide face of the decurling guide (for example, the guide face of the decurling guide 47).

According to this configuration, as described in Verification Test 1 above, rib marks in the image on the sheet is restrained from generating and the curl of the sheet is corrected reliably.

Aspect 5.

In Aspect 4, a relation of 15 mm≤G2y≤25 mm is satisfied.

According to this configuration, as described in Verification Test 2, the curl of the sheet is corrected more reliably.

Aspect 6.

In any one of Aspects 1 to 5, a relation of 15 mm≤R≤30 mm is satisfied, where R represents a minimum radius of curvature of the guide face of the decurling guide in an area in the +X direction from the point of −15 mm from the point of origin in the X direction.

According to this configuration, as described in Verification Test 1 above, rib marks in the image on the sheet is restrained from generating and the curl of the sheet is corrected reliably.

Aspect 7.

In any one of Aspects 1 to 6, the decurling guide (the decurling guide 47) includes two guide members, which are an upstream guide (for example, the fixing device exit guide 42) and a downstream guide (for example, the non-image forming side guide 43) in a sheet conveyance direction. A relation of 55 degrees≤θ1≤70 degrees is satisfied, where θ1 represents an angle between the Y direction and a direction of a tangent line of a guide face of the downstream guide (the guide face 43a of the non-image forming side guide 43) passing a downstream end of the upstream guide.

According to this configuration, as described in Verification Test 1 above, rib marks in the image on the sheet is restrained from generating and the curl of the sheet is corrected reliably.

Aspect 8.

In any one of Aspects 1 to 7, the image forming apparatus (for example, the image forming apparatus 100) further includes an opposite decurling guide (for example, the image forming side guide 44) facing the decurling guide (for example, the decurling guide 47) across a sheet conveyance passage. The opposite decurling guide includes a driven roller (for example, the driven roller 45).

According to this configuration, as described in Verification Test 1 above, rib marks in the image on the sheet is restrained from generating.

Aspect 9.

In any one of Aspects 1 to 8, the sheet conveyance direction at an exit of the fixing nip region (for example, the fixing nip region N) is inclined relative to a vertical direction of a ground contact surface of the image forming apparatus (for example, the image forming apparatus 100), in a direction away from a sheet ejection member (for example, the sheet ejection tray 101a). A relation of 10 degrees≤θ2≤20 degrees is satisfied, where θ2 represents an angle of inclination of the sheet conveyance direction at the exit of the fixing nip region, relative to the vertical direction.

According to this configuration, as described in Verification Test 2 above, a reduction in effect of correcting the curl of the sheet and occurrence of rib marks in the image formed on the sheet are restrained, and the number of sheets stackable in the sheet ejection member (the sheet ejection tray 101a) is increased.

The effects described in the embodiments of this disclosure are listed as most preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of the invention, and are included in the scope of the invention recited in the claims and its equivalent.

Any one of the above-described operations may be performed in various other ways, for example, in an order different from the one described above.

What is claimed is:

1. An image forming apparatus comprising:
an image forming device configured to form an image on a sheet;
a fixing device including
a heater;
a rotary heat member configured to be heated by the heater; and
a rotary nip forming member configured to contact the rotary heat member to form a fixing nip region,
the fixing device configured to pass the sheet with the image through the fixing nip region in a sheet conveyance direction, in which the sheet is conveyed, to fix the image to the sheet; and
a decurler including a decurling guide configured to correct a curl of the sheet while guiding the sheet after the fixing device,
the decurling guide having a guide face configured to face a surface of the sheet having contacted the rotary nip forming member in the fixing nip region,
the decurling guide configured to correct the curl of the sheet while guiding the sheet in a −X direction, where a downstream end of the fixing nip region in the sheet conveyance direction is a point of origin, the sheet conveyance direction at the point of origin is a Y direction, a direction perpendicular to the Y direction is an X direction, and a side toward the rotary nip forming member from the point of origin is a +X direction, and a direction opposite the +X direction is the −X direction, when the image forming apparatus is viewed from an axial direction of the rotary nip forming member,
a relation of 15 mm≤G1y≤25 mm being satisfied, where G1y represents a position from the point of origin in the Y direction at a point of −15 mm from the point of origin in the X direction on a guide face of the decurling guide.

2. The image forming apparatus according to claim 1,
wherein a relation of 15 mm≤G1y≤20 mm is satisfied.

3. The image forming apparatus according to claim 1,
wherein a relation of 150 mm/sec≤V≤350 mm/sec is satisfied, where V represents a conveying speed of the sheet.

4. The image forming apparatus according to claim 1,
wherein a relation of 15 mm≤G2y≤35 mm is satisfied, where G2y represents a position from the point of origin in the Y direction at a point of −30 mm from the point of origin in the X direction on the guide face of the decurling guide.

5. The image forming apparatus according to claim 4,
wherein a relation of 15 mm≤G2y≤25 mm is satisfied.

6. The image forming apparatus according to claim 1,
wherein a relation of 15 mm≤R≤30 mm is satisfied, where R represents a minimum radius of curvature of the guide face of the decurling guide in an area in the +X direction from the point of −15 mm from the point of origin in the X direction.

7. The image forming apparatus according to claim 1,
where the decurling guide includes an upstream guide and a downstream guide in the sheet conveyance direction, and
where a relation of 55 degrees≤θ1≤70 degrees is satisfied, where θ1 represents an angle between the Y direction and a direction of a tangent line of a guide face of the downstream guide passing a downstream end of the upstream guide.

8. The image forming apparatus according to claim 1, further including an opposite decurling guide disposed facing the decurling guide across a sheet conveyance passage,
wherein the opposite decurling guide includes a driven roller.

9. The image forming apparatus according to claim 1,
wherein the sheet conveyance direction at an exit of the fixing nip region is inclined relative to a vertical direction of a ground contact surface of the image forming apparatus, in a direction away from a sheet ejection member, and
wherein a relation of 10 degrees≤θ2≤20 degrees is satisfied, where θ2 represents an angle of inclination of the sheet conveyance direction at the exit of the fixing nip region, relative to the vertical direction.
